(19) United States
(12) Patent Application Publication
(10) Pub. No.: US 2025/0123387 A1
(43) Pub. Date: Apr. 17, 2025

(54) SENSING OPERATION USING MEASUREMENTS BASED ON A CIRCULAR DIRECTED GRAPH

(71) Applicant: Lenovo (Singapore) Pte. Ltd., Singapore (SG)

(72) Inventors: Seyedomid Taghizadeh Motlagh, Oberursel (DE); Ali Ramadan Ali, Kraiburg am Inn (DE); Robin Rajan Thomas, Bad Nauheim (DE); Vijay Nangia, Woodridge, IL (US)

(21) Appl. No.: 18/912,459

(22) Filed: Oct. 10, 2024

Related U.S. Application Data
(60) Provisional application No. 63/589,563, filed on Oct. 11, 2023.

(51) Int. Cl. G01S 13/76; H04W 24/10

(52) U.S. Cl. CPC G01S 13/765; H04W 24/10

(57) ABSTRACT

Various aspects of the present disclosure relate to receiving a sensing configuration for performing a sensing signal transmission and at least one sensing measurement; performing at least one sensing measurement based on a first sensing signal; transmitting a second sensing signal in accordance with the sensing configuration, wherein the sensing configuration indicates a time difference between a reception of the first sensing signal and a time of transmission of the second sensing signal or a time reference, or a frequency difference between the reception of the first sensing signal and a transmission frequency of the second sensing signal or a frequency reference, or both; and transmitting a measurement report based at least in part on the at least one sensing measurement.

### TECHNICAL FIELD

The present disclosure relates to wireless communications, and more specifically to techniques for performing a radio-based sensing operation using measurements based on a circular directed graph.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). As used herein, a list with a conjunction of “and/or” includes any single item in the list or a combination of items in the list. For example, a list of A, B and/or C includes only A, or only B, or only C, or AB, or BC, or AC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations, the method and apparatuses described herein may further include a means for receiving a sensing configuration for performing a sensing signal transmission and at least one sensing measurement. The method and apparatuses described herein may include a means for performing at least one sensing measurement based on a first sensing signal. The method and apparatuses described herein may include means for transmitting a second sensing signal in accordance with the sensing configuration, wherein the sensing configuration indicates a time difference between a reception of the first sensing signal and a time of transmission of the second sensing signal, or a frequency difference between the reception of the first sensing signal and a transmission frequency of the second sensing signal, or both. The method and apparatuses described herein may include means for transmitting a measurement report based at least in part on the at least one sensing measurement.

In some implementations of the method and apparatuses described herein may include a means for determining a set of radio nodes for performing sensing signal transmission and sensing measurements. The set of radio nodes forms a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. Further, a starting vertex a respective directional edge corresponds to a transmitting radio node associated with a transmission of a respective sensing signal, and a terminating vertex of the respective directional edge corresponds to a receiving radio node associated with a reception and measurement of the respective sensing signal. The method and apparatuses described herein may include a means for transmitting, to the set of radio nodes, a sensing configuration for performing the sensing signal transmission and the sensing measurements. The method and apparatuses described herein may include a means for receiving at least one measurement report corresponding to the sensing signal transmission and sensing measurements. The method and apparatuses described herein may include means for determining sensing information based at least in part on combined measurement values associated with the plurality of directional edges.

### BRIEF DESCRIPTION OF THE DRAWINGS

FIG. 1 illustrates an example of a wireless communications system in accordance with aspects of the present disclosure.

FIG. 2 illustrates an example of a Third Generation Partnership Project (3GPP) New Radio (NR) protocol stack showing different protocol layers in the UE and network, in accordance with aspects of the present disclosure.

FIG. 3 illustrates an example of an instance of a radio sensing measurement procedure, in accordance with aspects of the present disclosure.

FIG. 4A illustrates an example of a first set of sensing scenarios for a radio sensing operation, in accordance with aspects of the present disclosure.

FIG. 4B illustrates an example of a second set of sensing scenarios for a radio sensing operation, in accordance with aspects of the present disclosure.

FIG. 5A illustrates an example of a tight coupling Information Sharing and Analysis Center (ISAC) network architecture, in accordance with aspects of the present disclosure.

FIG. 5B illustrates another example of a tight coupling ISAC network architecture, in accordance with aspects of the present disclosure.

FIG. 5C illustrates an example of an ISAC network architecture where the sensing function (SF) is co-located with the location management function (LMF), in accordance with aspects of the present disclosure.

FIG. 5D illustrates an example of a loose coupling ISAC network architecture, in accordance with aspects of the present disclosure.

FIG. 6A illustrates a first example of a circular directed graph of measurement nodes, in accordance with aspects of the present disclosure.

FIG. 6B illustrates a second example of a circular directed graph of measurement nodes, in accordance with aspects of the present disclosure.

FIG. 6C illustrates a third of a circular directed graph of measurement nodes, in accordance with aspects of the present disclosure.

FIG. 6D illustrates a fourth example of a circular directed graph of measurement nodes, in accordance with aspects of the present disclosure.

FIG. 7 illustrates an example of a bi-directional sensing measurement operation, in accordance with aspects of the present disclosure.

FIG. 8 illustrates an example of two circular directed graphs with a set of common nodes, in accordance with aspects of the present disclosure.

FIG. 9 illustrates an example of a timeline with an implicit measurement combination, in accordance with aspects of the present disclosure.

FIG. 10A illustrates an example of a UE-assisted Multiple Round-Trip Time (Multi-RTT) sensing procedure, in accordance with aspects of the present disclosure.

FIG. 10B is a continuation of the procedure illustrated in FIG. 10A.

FIG. 11 illustrates an example of a sensing group configuration, in accordance with aspects of the present disclosure.

FIG. 12 illustrates another example of a sensing group configuration, in accordance with aspects of the present disclosure.

FIG. 13 illustrates an example of a user equipment (UE) 1300, in accordance with aspects of the present disclosure.

FIG. 14 illustrates an example of a processor 1400, in accordance with aspects of the present disclosure.

FIG. 15 illustrates an example of a network equipment (NE) 1500, in accordance with aspects of the present disclosure.

FIG. 16 illustrates a flowchart of a method performed by a sensing measurement controller, in accordance with aspects of the present disclosure.

FIG. 17 illustrates a flowchart of a method performed by a participating radio node, in accordance with aspects of the present disclosure.

### DETAILED DESCRIPTION

Generally, the present disclosure describes systems, methods, and apparatuses for cell measurement and access to network energy saving cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

Radio-based environment sensing allows for improved the network performance of the cellular wireless networks, as well as enabling the cellular wireless networks to serve vertical use-cases, e.g., where sensing information is obtained (and exposed to the requesting entity) by the wireless communication network. As such, a radio sensing measurement procedure intends to generate and collect measurements to obtain sensing information of the target objects/environment and/or the involved radio nodes. Examples of the acquired sensing information (also referred to as “sensing results”) includes, but is not limited to, information of position, velocity, direction/heading, orientation, radar cross-section (RCS), shape, material/composite, etc., of a target object and/or of a participating radio node.

Such sensing information may be obtained by means of combination of the one or multiple of: i) transmission of a sensing signal, e.g., a sensing reference signal (RS), from a network or UE entity (hereafter referred to as a “sensing Tx node”); ii) reception of the reflections/echoes of the transmitted sensing excitation signal from the environment by a network or a UE entity (hereafter referred to as a “sensing Rx node”); and/or iii) processing of the received reflections and inferring relevant information from the environment.

Accordingly, the sensing measurement process may include: i) one or multiple (static or mobile) sensing Tx nodes with known sensing information or with (partially) unknown sensing information (e.g., known or unknown position); ii) one or multiple (static or mobile) sensing Rx nodes with known or (partially) unknown sensing information (e.g., known or unknown position); iii) one or multiple (static or mobile) objects/reflectors with known or (partially) unknown sensing information (e.g., known or unknown position, presence, RCS, etc.); or a combination thereof.

Aspects of the present disclosure are described in the context of a wireless communications system.

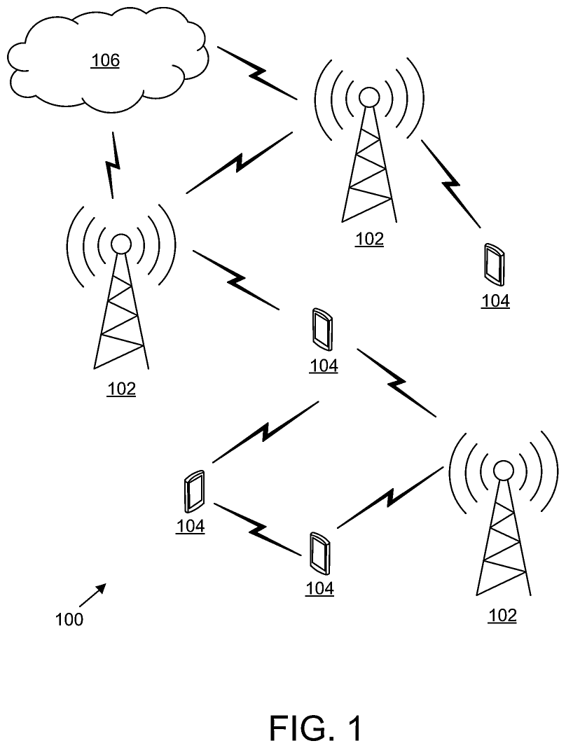

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink (SL). For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For initial access, a UE 104 detects a candidate cell and performs downlink (DL) synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of system information block type 1 (SIB1) in high frequency bands (e.g., 28 GHz). As discussed in further detail below, the SSB (or another RS defined within the wireless communication system 100) may be utilized as a sensing RS signal and a UE 104 (and/or NE 102) may perform sensing measurements based on the SSB transmission.

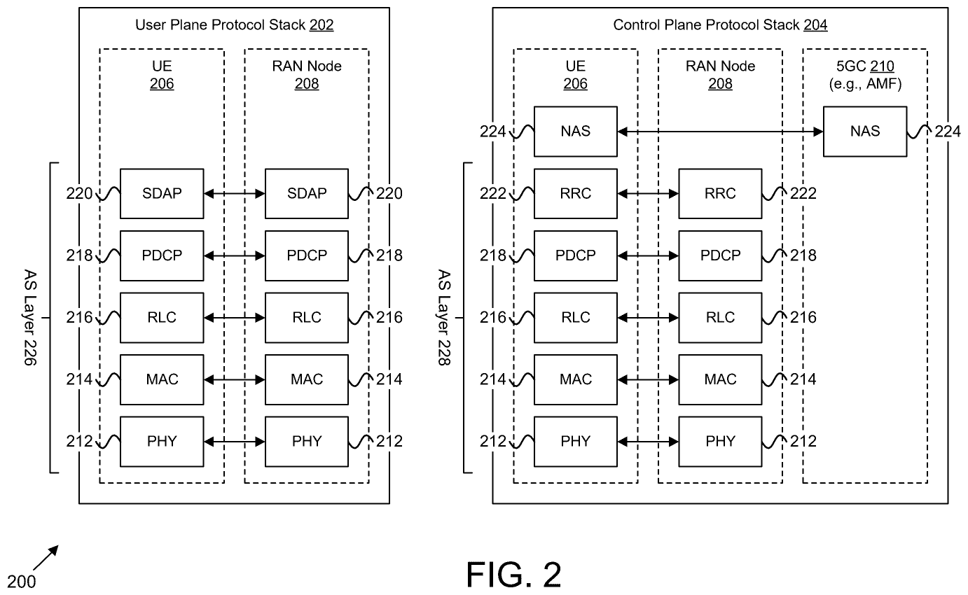

FIG. 2 illustrates an example of a NR protocol stack 200, in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the NR protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) sublayer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as uplink (UL) or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

Note that an LTE protocol stack comprises similar structure to the NR protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

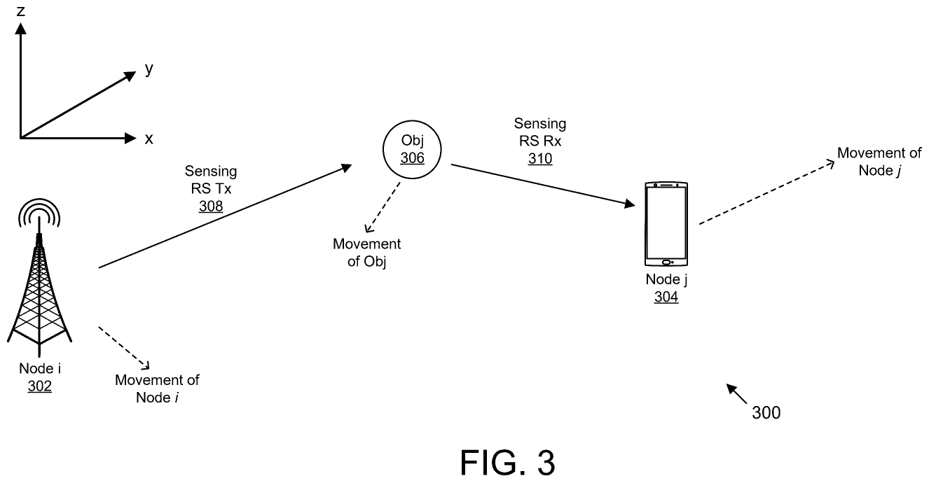

FIG. 3 illustrates an example of an instance 300 of a radio sensing measurement procedure, in accordance with aspects of the present disclosure. FIG. 3 illustrates a first sensing node (denoted “Node i”) 302 acting as a sensing transmitter (Tx) node in the instance 300, a second sensing node (denoted “Node j”) 304 acting as a sensing receiver (Rx) node in the instance 300, and a target object (denoted “Obj”) 306 whose sensing information is derived by the radio sensing measurement procedure. In the depicted instance 300, the Node i 302 performs the sensing RS transmission 308 and the Node j 304 performs the sensing RS reception 310. In some embodiments, the Node i 302 is static (i.e., not moving, having a fixed position). In other embodiments, the Node i 302 is mobile (i.e., moving). Similarly, in some embodiments, the Node j 304 is static (i.e., not moving, having a fixed position). In other embodiments, the Node j 304 is mobile (i.e., moving).

Each radio node that participates in the radio sensing measurement procedure has a position (p) and a velocity (v). In some embodiments, the position of a radio node is known to the network. In other embodiments, the position of the radio node is unknown. In some embodiments, the velocity of a radio node is known to the network. In other embodiments, the velocity of the radio node is unknown. Note that the participating radio node may be a UE, a gNB, or a transmit-receive point (TRP).

The Node i 302 and the Node j 304 are each elements of the set M, which is the set of transmission-reception (Tx-Rx) measurement pairs of radio nodes. Let [symbol] represent the set of reflectors and/or objects (reflectors/objects) and sensing Rx nodes with known or partially known sensing information. Let [symbol] represent the set of entities of interest with unknown or partially unknown sensing information and for which sensing information is to be estimated. Note that the set [symbol] _{X} may be a subset of the set [symbol] .

Note that the radio sensing measurement procedure is not restricted to the Tx-Rx scenarios with object/reflections, and may include the direct Tx/Rx line-of-sight (LoS) measurements, e.g., the LoS time-of-flight (ToF) or the LoS Angle-of-Arrival (AoA) estimation. For the instance 300 of the radio sensing measurement procedure, the following identities and timing, angular, doppler equalities are known to inform on the sensing information of the object and/or the radio nodes: True ToF value, Estimated ToF value, True doppler shift value, Estimated doppler shift value, True AoA and Zenith-of-Arrival (ZoA) values, Estimated AoA and ZoA values.

The true ToF value, according to the defined scenario parameters, is expressed as:

$$ToF ( {p}_{obj} , {p}_{i} , {p}_{j} ) = {‖ {p}_{obj} - {p}_{i} ‖}_{2} / c + {‖ {p}_{obj} - {p}_{j} ‖}_{2} / c \qquad Eq . 1$$

where p_{obj} is the position of the target object 306, pᵢ is the position of the Node i 302, pⱼ is the position of the Node j 304, and c is the speed of light.

The estimated ToF at the receiver Node j 304 at the time instance t, including impact of the time synchronization mismatch (assumed to be constant during the measurement period) between the Tx-Rx node pairs denoted by Δ_{T,ij} as well as the impact of the additive noise on the measurement (e.g., including impact of non-constant clock offset), denoted by n_{T,j(t)}, is expressed as:

$$T \tilde{o} {F}_{j} ( {p}_{obj} , {p}_{i} , t ) = {‖ {p}_{obj} - {p}_{i} ‖}_{2} / c + {‖ {p}_{obj} - {p}_{j} ‖}_{2} / c + {Δ}_{T , ij} + {n}_{T , j} ( t ) \qquad Eq . 2$$

$$( i , j ) ∈ , obj ∈$$

The true doppler shift value, according to the defined scenario parameters, is expressed as:

$${f}_{D} ( {p}_{obj} , {v}_{obj} , {p}_{i} , {v}_{i} , {p}_{j} , {v}_{j} ) = {( {v}_{i} - {v}_{obj} )}^{T} \frac{{p}_{obj} - {p}_{i}}{λ {‖ {p}_{obj} - {p}_{i} ‖}_{2}} + {( {v}_{j} - {v}_{bj} )}^{T} \frac{{p}_{obj} - {p}_{j}}{λ {‖ {p}_{obj} - {p}_{j} ‖}_{2}} \qquad Eq . 3$$

where the notation (.)^{T} denotes the transpose, where v_{obj} is the velocity of the target object 306, vᵢ is the velocity of the Node i 302, vⱼ is the velocity of the Node j 304, and X is the wavelength of the transmitted sensing signal.

The estimated doppler shift value at the receiver Node j 304, including impact of the constant (during the measurement period) frequency synchronization mismatch/offset between the Tx-Rx node pairs, denoted as Δ_{F,ij}, as well as the impact of additive noise (including non-constant frequency offset) on the measurement, is expressed as:

$${\overline{f}}_{D , j} ( {p}_{obj} , {v}_{obj} , {p}_{i} , {v}_{i} , t ) = {( {v}_{i} - {v}_{obj} )}^{T} \frac{{p}_{obj} - {p}_{i}}{λ {‖ {p}_{obj} - {p}_{i} ‖}_{2}} + {( {v}_{j} - {v}_{obj} )}^{T} \frac{{p}_{obj} - {p}_{j}}{λ {‖ {p}_{obj} - {p}_{j} ‖}_{2}} + {Δ}_{F , ij} + {n}_{D , j} ( t ) \qquad Eq . 4$$

The true AoA and ZoA values, wherein ∠_{Z}, ∠_{A} compute the zenith and azimuth angle of a vector presented in the cartesian space, respectively, are expressed as:

$${A}_{Z} ( {p}_{obj} , {p}_{i} , {p}_{j} ) = {∠}_{Z} ( {p}_{j} - {p}_{obj} ) \qquad Eq . 5$$

$${A}_{A} ( {p}_{obj} , {p}_{i} , {p}_{j} ) = {∠}_{A} ( {p}_{j} - {p}_{obj} )$$

The estimated AoA and ZoA values at the receiver Node j 304, including impact of constant (during the measurement period) coordinate system mismatch (angular synchronization) in the azimuth and zenith directions (denoted as Δ_{z,j}, Δ_{A,j}) and impact of additive noise on the measurement process, are expressed as:

$${\tilde{A}}_{A , j} ( {p}_{obj} , {p}_{i} , t ) = {∠}_{A} ( {p}_{obj} , {p}_{i} ) + {Δ}_{A , j} + {n}_{A , j} ( t ) \qquad Eq . 6$$

$${\tilde{A}}_{Z , j} ( {p}_{obj} , {p}_{i} , t ) = {∠}_{Z} ( {p}_{obj} - {p}_{i} ) + {Δ}_{Z , j} + {o}_{Z , j} ( t )$$

Upon acquisition of the above-defined measurement estimates as expressed in Equation 2, Equation 4, and Equation 6, and utilizing the knowledge of the structures as expressed in Equation 1, Equation 3, and Equation 5, the estimation of the object and/or radio Tx-Rx node positioning/sensing information can be then obtained, e.g., following a loss-minimization approach, wherein a loss function represents a measure of observable error (of the positioning variables of interest) from the collected measurements.

In some embodiments, the least square example loss-function can be hence utilized as:

$$L ( \{ {p}_{obj} , {v}_{obj} \} , \{ {p}_{i} , {v}_{i} , {p}_{j} , {v}_{j} \} ) = {\sum }_{t ∈ 𝒯} {\sum }_{obj ∈ 𝒪} {\sum }_{( i , j ) ∈ ℳ} \{ {W}_{T} {‖ T \tilde{o} {F}_{j} ( {p}_{obj} , {p}_{i} , t ) - ToF ( {p}_{obj} , {p}_{i} , {p}_{j} ) ‖}_{2}^{2} + {W}_{D} {‖ {\tilde{f}}_{D , j} ( {p}_{obj} , {v}_{obj} , {p}_{i} , {v}_{i} , t ) - {f}_{D} ( {p}_{obj} , {v}_{obj} , {p}_{i} , {v}_{i} , {p}_{j} , {v}_{j} ) ‖}_{2}^{2} + {W}_{A} {‖ {\tilde{A}}_{A , j} ( {p}_{obj} , {p}_{i} , t ) - {A}_{A} ( {p}_{obj} , {p}_{i} , {p}_{j} ) ‖}_{2}^{2} + {W}_{Z} {‖ {\tilde{A}}_{Z , j} ( {p}_{obj} , {p}_{i} , t ) - {A}_{Z} ( {p}_{obj} , {p}_{i} , {p}_{j} ) ‖}_{2}^{2} \} \qquad Eq . 7$$

wherein the positive-real valued weights W_{T}, W_{D}, W_{A}, W_{Z} represent significance of different measurement parts, associated with the ToF estimates, doppler estimates, and azimuth and elevation angular estimates, respectively.

The estimate of the position and velocity of the object and/or radio nodes, described as obj∈ [symbol] _{X}, is hence obtained as a minimizer of the constructed Loss function, and expressed as:

$${\{ \tilde{{p}_{obj}} , \tilde{{v}_{obj}} \}}_{obj ∈ {X}_{}} = \{ L ( \{ {p}_{obj} , {v}_{obj} \} , \{ {p}_{i} , {v}_{i} , {p}_{j} , {v}_{j} \} ) \} \qquad Eq . 8$$

Please note that the above identities and parameter estimates are not intended to be limited to a transmission-reflection-reception setup, and the related LoS measurements of a Tx-Rx path (e.g., LoS ToF, AoA, doppler shift etc.) can be obtained by setting the object as the receiver node (i.e., obj=j∈ [symbol] ) and eliminating the parts of the expression including p_{obj}−pⱼ and v_{obj}−vⱼ, i.e., eliminating the terms expressing the impact of object-Rx propagation.

The following observations follow from the expressions of Equations 1-8 relating the estimates of a desired sensing information (e.g., a radio node or object's position or velocity information) to the inherent inaccuracies of the measurement process, more prominently, the unknown but constant (during the measurement process) offset of time, frequency and angular reference of a Tx-Rx node, and the dynamic additive noise.

Observation 1: The loss function is lower bounded as following, wherein the bound is achieved upon infinitely accurate estimation of the unknown sensing variables

[symbol]

$$L ( \{ {p}_{obj} , {v}_{obj} \} , \{ {p}_{i} , {v}_{i} , {p}_{j} , {v}_{j} ) \} \geq {\sum }_{t ∈ 𝒯} \{ {W}_{T} {‖ {Δ}_{T , ij} + {n}_{T , j} ( t ) ‖}_{2}^{2} + {W}_{D} {‖ {Δ}_{D , ij} + {n}_{D , j} ( t ) ‖}_{2}^{2} + {W}_{A} {‖ {Δ}_{A , ij} + {n}_{A , j} ( t ) ‖}_{2}^{2} + {W}_{Z} {‖ {Δ}_{Z , ij} + {n}_{Z , j} ( t ) ‖}_{2}^{2} \} \qquad Eq . 9$$

Observation 2: The inflicted measurement errors (including constant and variable offsets) are (almost) independent from the known and unknown sensing information of the objects and/or the radio nodes (e.g., the frequency offset of a sensing Rx node is statistically independent from the node position), and hence cannot be inferred/obtained (and hence removed) based on the available problem data (e.g., known node position, velocity, etc.).

Observation 3: It is observed that the UE basic measurement interval of modulated carrier frequency is 1 UL slot. 3GPP specifications state that the mean value of basic measurements of UE modulated carrier frequency shall be accurate to within ±0.1 parts per million (PPM) observed over a period of 1 ms of cumulated measurement intervals compared to the carrier frequency received from the gNB. The stated carrier frequency offset of +/−0.1 PPM contributes significantly to the established error lower bound in Equation 9 and may lead to a mismatch of +/−30 m/sec of velocity estimate for a single measurement point, assuming a direction of movement along the object-sensing Rx node or along the object sensing Tx node.

Observation 4: The time and angular synchronization quality of a UE with a reference device may be limited depending on the device type and/or the usage scenario, e.g., an out-of-coverage UE with no accurate synchronization reference and a UE with dynamic position and orientation (due to the hand/head movement). The inaccuracies further contribute to the error terms of Equation 9 and lead to impaired quality of the sensing measurements.

In view of the above observations, and further in view of the required sensing key performance indicators (KPI), e.g., the use case KPIs with sub-meter and/or sub-meter/see position, and velocity estimate accuracy requirements, the present disclosure describes techniques whereby the correlation among the erroneous parts of the estimation error lower bound as established in Equation 9, among multiple sensing measurements of different paths, different nodes and at different time instances etc., is utilized to reduce/compensate the error of the sensing measurements, wherein the sensing measurements are performed in the context of a wireless cellular networks and for the purpose of obtaining a desired sensing information of a target object and/or of radio node.

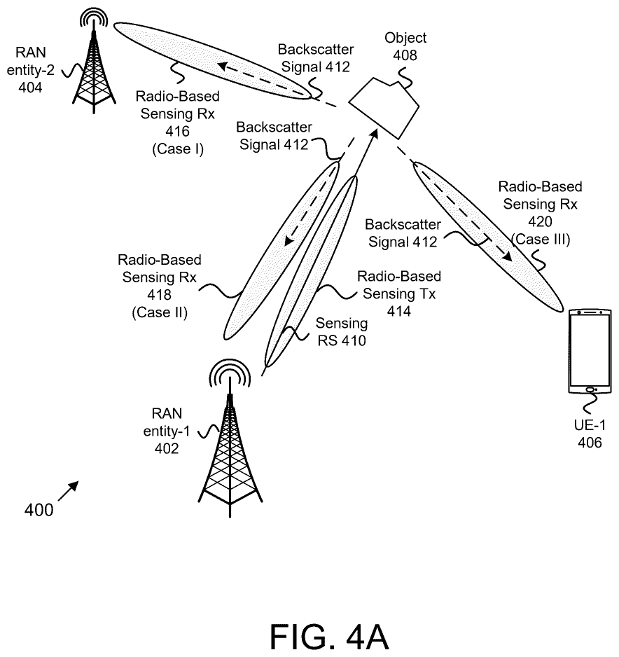

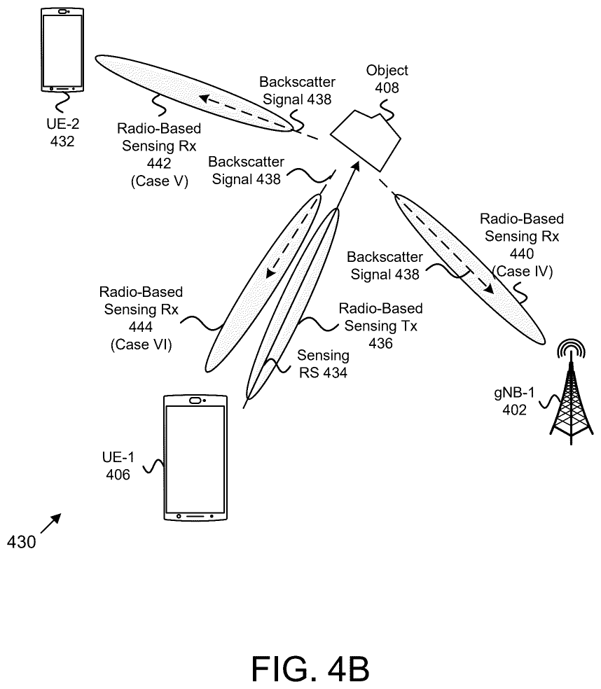

Regarding network-based and UE-based (i.e., SL-based) radio sensing operations, different scenarios for radio sensing are presented in FIGS. 4A and 4B. In some scenarios of radio sensing, the network configures the participating sensing entities, i.e., network and UE nodes acting as sensing Tx nodes, network and UE nodes acting as sensing Rx nodes, as well as the configuration of sensing RS and necessary measurements and reporting procedures from the nodes. In this regard, the functional split between the network and the UE nodes for a specific sensing task may take various forms, depending on the availability of sensing-capable devices and the requirements of the specific sensing operation.

FIG. 4A depicts possibilities for sensing scenarios for a radio sensing operation 400 where a RAN entity performs a sensing RS transmission, according to embodiments of the disclosure. In the scenarios of FIG. 4A, sensing RS reception is performed by one or more UEs, one or more RAN entities, or a combination thereof. The radio sensing operation 400 may involve a first RAN entity 402 (e.g., a gNB or network TRP node), a second RAN entity 404 (e.g., a gNB or a network TRP node), and/or a set of at least one UE (represented by the first UE 406).

In various embodiments, the radio sensing operation 400 is used to detect and locate an object of interest 408. In general, a Radio-based sensing transmission 410 is performed by the first RAN entity 402. While the below examples describe the Radio-based sensing transmission 410 using a sensing reference signal (“sensing RS”) 412, in other embodiments the Radio-based sensing transmission 410 may be a transmission of another RS or instead may be a transmission of the data/control channels known to the network TRP nodes.

In a first sensing scenario (also referred to herein as “Case I”), the Radio-based sensing transmission 410 is performed by a first network node (i.e., the first RAN entity 402) and the Radio-based sensing reception 416 is performed by a separate network node (i.e., the second RAN entity 404). In this case, the sensing RS 412 (or another RS used for sensing) is transmitted and a reflection/backscatter signal 414 is received by network entities. The network does not utilize UEs for sensing assistance in this scenario. Rather, the involvement of UE nodes (i.e., first UE 406) is limited to the aspects of interference management, when necessary.

In a second sensing scenario (also referred to herein as “Case II”), the Radio-based sensing transmission 410 is performed by a first network node (i.e., the first RAN entity 402) and the Radio-based sensing reception 418 is performed by the same network node. In this case, the sensing RS 412 (or another RS used for sensing) is transmitted and a reflection/backscatter signal 414 is received by the same network entity. The network does not utilize UEs for sensing assistance in this scenario. Rather, the involvement of UE nodes (i.e., first UE 406) is limited to the aspects of interference management, when necessary.

In a third sensing scenario (also referred to herein as “Case III”), the Radio-based sensing transmission 410 is performed by a first network node (i.e., the first RAN entity 402) and the Radio-based sensing reception 420 is performed by a UE node (i.e., the first UE 406). In this case, the sensing RS 412 (or other RS used for sensing) is transmitted by a network entity and a reflection/backscatter signal 414 is received by one or multiple UE nodes, including the first UE 406. The network configures the UEs to act as a sensing Rx node, according to the UE capabilities for sensing, as well as desired sensing task.

FIG. 4B depicts possibilities for sensing scenarios for a radio sensing operation 430 where a UE performs a sensing RS transmission, according to embodiments of the disclosure. In the scenarios of FIG. 4B, sensing RS reception is performed by one or more UEs, one or more RAN entities, or a combination thereof. The radio sensing operation 430 may involve the first UE 406, a set of at least one peer UE (represented by the second UE 432), and/or a set of at least one TRP (represented by the first RAN entity 402).

In various embodiments, the radio sensing operation 430 is used to detect and locate an object of interest 408. In general, a Radio-based sensing transmission 434 is performed by the first UE 406. While the below examples describe the Radio-based sensing transmission 434 using a sensing RS 436, in other embodiments the Radio-based sensing transmission 434 may be a transmission of another RS or instead may be a transmission of the data/control channels.

In a fourth sensing scenario (also referred to herein as “Case IV”), the Radio-based sensing transmission 434 is performed by a first UE 406 and the Radio-based sensing reception 440 is performed by a RAN entity (i.e., the first RAN entity 402). In this case, the sensing RS 436 (or another RS transmitted for sensing) is transmitted by a UE node and a reflection/backscatter signal 438 is received by one or multiple network entities. The network configures the transmitting UE (i.e., the first UE 406) to act as a sensing Tx node, according to the UE nodes' capabilities for sensing, as well as the nature of the desired sensing task.

In a fifth sensing scenario (also referred to herein as “Case V”), the Radio-based sensing transmission 434 is performed by a first UE 406 and the Radio-based sensing reception 442 is performed by a separate UE (i.e., the second UE 432). In this case, the sensing RS 436 (or another RS transmitted for sensing) is transmitted by a UE node and a reflection/backscatter signal 438 is received by one or multiple UE nodes. The network, or potentially the first UE 406, may decide on configuration of the sensing scenario. In one instance, the network configures the UEs to act as a sensing Tx node and/or sensing Rx nodes, according to the UE nodes capabilities for sensing, as well as the nature of the desired sensing task.

In a sixth sensing scenario (also referred to herein as “Case VI”), the Radio-based sensing transmission 434 is performed by a first UE 406 and the Radio-based sensing reception 444 is performed by the same UE. In this case, the sensing RS 436 (or another RS transmitted for sensing) is transmitted by a UE node and a reflection/backscatter signal 438 is received by the same UE node. The UE or the network configures the sensing scenario, according to the UE nodes capabilities for sensing, as well as the nature of the desired sensing task.

The above radio sensing scenarios are described in further detail in U.S. application Ser. No. 17/538,978 entitled “CONFIGURING A SENSING REFERENCE SIGNAL” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, and also described in further detail in U.S. application Ser. No. 17/538,998 entitled “SENSING REFERENCE SIGNAL CONFIGURATION” and filed on Nov. 30, 2021 for Seyedomid Taghizadeh Motlagh, Ali Ramadan Ali, Ankit Bhamri, Sher Ali Cheema, Razvan-Andrei Stoica, Hyejung Jung and Vijay Nangia, which applications are incorporated herein by reference.

Moreover, the above scenarios are not intended to be restricted to a specific UE type, and may include any UE category. In any of the above scenarios, and of the roles elaborated for gNB and/or UE may be replaced (with equal validity for any example of a radio sensing scenario) with any UE or RAN node, e.g., a smart repeater node, an Integrated Access and Backhaul (IAB) node, a road side unit (RSU), etc. In some examples, the set of sensing Tx nodes of a sensing measurement process (and similarly, but may be independently, a sensing Rx nodes of a sensing measurement process) include one or more of a TRP associated with a gNB-CU/DU, a gNB distributed unit (gNB-DU), a gNB control unit (gNB-CU), a UE, a network controlled repeater (NCR), an IAB node, an RSU, or a dedicated sensing radio. In some embodiments, a sensing Rx node may as well be a non-3GPP sensor with capability of providing non-3GPP sensing data, or a 3GPP node (e.g., a UE or a RAN node) connected to the non-3GPP sensor and can obtain, process, and transfer the non-3GPP sensing data of the non-3GPP sensor to other 3GPP nodes/entities.

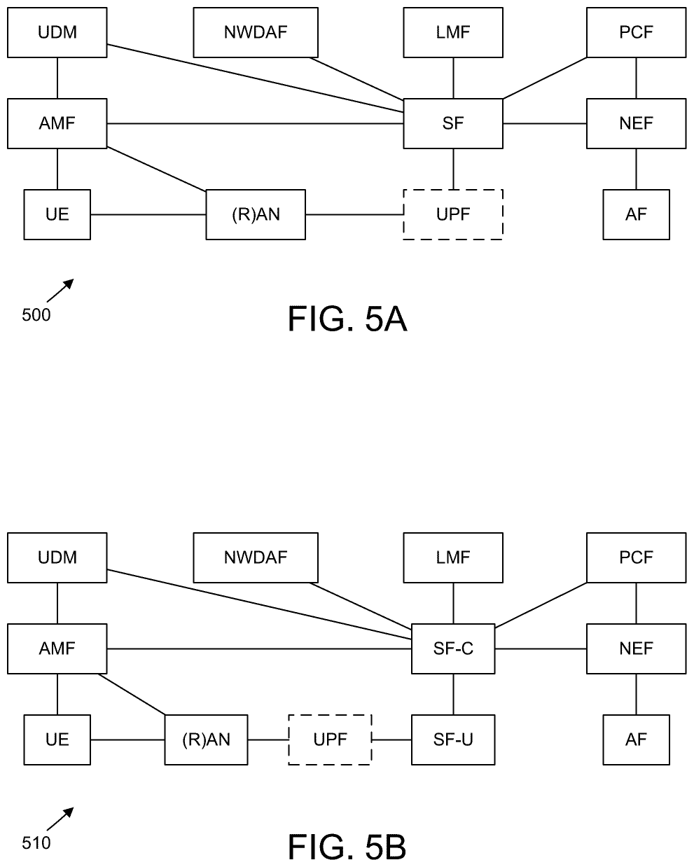

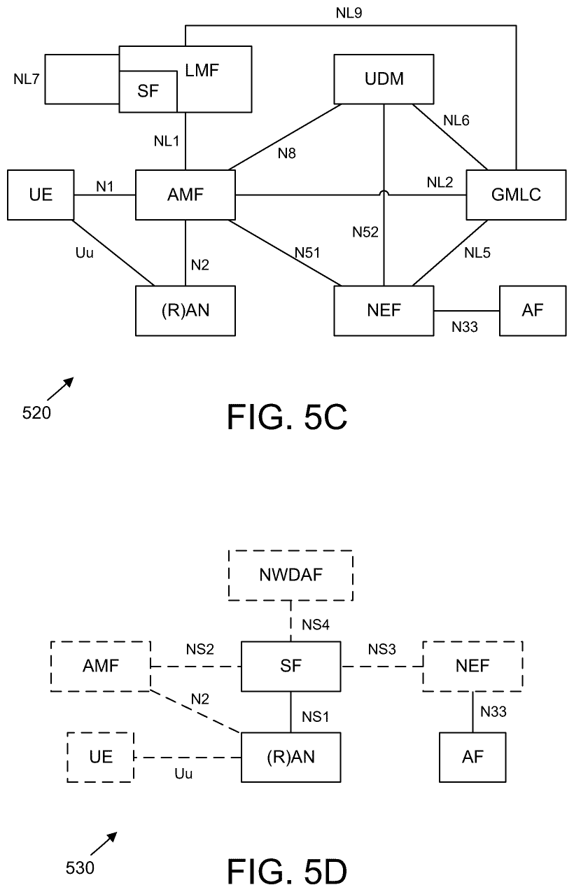

Integrated sensing and communication may enhance 5G core architecture by introducing a new Sensing Function (SF). FIGS. 5A-5D present possible combinations leading to the network impact.

FIG. 5A illustrates an example of a tight coupling ISAC network architecture 500 with a unified SF (i.e., where the SF is not split between the control plane (CP) and user plane (UP) domains. As depicted, the SF is communicatively coupled to the Access and Mobility management Function (AMF), the Unified Data Management node (UDM), the Network Data Analytics Function (NWDAF), the Location Management Function (LMF), the Policy Control Function (PCF), the Network Exposure Function (NEF), and to the (radio) access network ((R)AN), optionally via the User Plane Function (UPF).

In the tight coupling ISAC network architecture 500, the SF appears as a dedicated network function (NF) handling both: (i) the sensing control plane aspects such as the interaction with the sensing consumer via NEF and information exchange with other NFs, for gathering UE information, (i.e., from the AMF, the UDM, the LMF), for gathering UE related policies from the PCF, and for gathering analytics from the NWDAF; and (ii) the sensing radio signals for performing the analysis or prediction for determining the sensing target.

FIG. 5B illustrates another example of a tight coupling ISAC network architecture 510, where the SF is functionally split/distributed among the CP and UP domains. As depicted, a CP split of the SF (SF-C) is communicatively coupled to the AMF, the UDM, the NWDAF, the LMF, the PCF, and the NEF. Additionally, a UP split of the SF (SF-C) is communicatively coupled to the (R)AN, optionally via the UPF.

In the tight coupling ISAC network architecture 510 with CP/UP split, the SF has two dedicated NF counter parts: (i) SF-C that handles the control plane aspects as described above and (ii) SF-U that is responsible for collecting the sensing radio signals via the user plane, i.e., via the (R)AN and the UPF. The idea of this architecture is to split and offload heavy data volumes associated with sensing radio signals to the user plane to ensure light traffic, i.e., only signaling, in the control plane.

FIG. 5C illustrates an example of an ISAC network architecture 520, where the SF is co-located with the LMF. The SF is communicatively coupled with the LMF, where the co-located nodes are also coupled with the Gateway Mobile Location Center (GMLC) and the AMF. As depicted, the GMLC is additionally coupled with the UDM, the AMF and the NEF. The AMF is additionally coupled with the UDM, the NEF, the (R)AN, and the UE. The NEF is additionally coupled with the application function (AF). The (R)AN is additionally coupled with the UE. The inter-function interfaces (i.e., reference points) are labeled in FIG. 5C. In the ISAC network architecture 520, the SF (i.e., co-located with the LMF) appears as a logical NF embedded in the LMF to perform sensing taking advantage of the knowledge of a UE location.

FIG. 5D illustrates an example of a loose coupling ISAC network architecture 530, where the SF is communicatively coupled with the (R)AN and with the AF, optionally via the NEF. The SF may optionally be coupled with one or more of: the AMF (directly or via the (R)AN), the NWDAF, the NEF, and the UE (via the (R)AN). The inter-function interfaces (i.e., reference points) are labeled in FIG. 5C.

In the loose coupling ISAC network architecture 530, the SF is independent of the 5G core, i.e., typically used for local field scenarios or private networks, and the interaction with the 5G core is minimal. The main idea is to use SF close to the RAN, i.e., collect and process the sensing radio signals locally, and interact with 5G core for the purpose of exposure via NEF, for getting the UE location from the AMF and for analytics (i.e., NWDAF interaction).

In another description of controlling a sensing operation, in some example implementations, a sensing controller entity/function (e.g., a sensing management function (SensMF)) is defined which comprises one or multiple of a UE, a RAN node, a gNB/gNB-CU, an LMF, an SF, or a combination thereof, wherein the SensMF performs one or multiple of: A) Receives request for sensing information from a service consumer (e.g., a requesting third party application); B) Determines selection and/or configuration of a sensing operation, including configuration of one or more of a sensing Tx node, sensing Rx node; C) Selects and/or configures the involved nodes for sensing transmission and sensing reception and sensing measurement and reporting of the conducted measurements; D) Collects the sensing measurements; E) Performs or configures or requests computation of the sensing measurements and thereby determines the required sensing information based on the obtained sensing measurements; and/or F) Reports/exposes an obtained sensing information to the entity requesting the sensing information.

In some examples wherein the SensMF is comprised of multiple nodes/entities, one part of the above-mentioned steps may be implemented by the first part of the SensMF and the second part of the above steps may be implemented by the second part of the SensMF, e.g., implemented in the SF and gNB. In some examples wherein the SensMF is comprised of multiple nodes/entities, the communication among the SensMF entities are transparent to the outside entities and also not discussed in the related handover procedure embodiments, nevertheless, the communication among the SensMF entities are assumed to be implicit to the overall procedure.

In some examples, wherein a SensMF is comprised of an SF and a gNB (e.g., serving/head gNB of a related UE to the sensing task or a selected serving gNB for a sensing task), the SF performs the steps A, F, E, D whereas the steps B, C are performed by the selected gNB node. In some other examples, the step B, D are jointly performed by the SF and the selected gNB, wherein a first part of the configuration/configuration determination are performed by the SF and a second part of the configuration/configuration determination is performed by the selected gNB. The SensMF may be a RAN node (e.g., a selected gNB node acting as serving gNB of a sensing task), may be a sensing function (SF) residing in core network, may be a UE, or a combination thereof.

The following L1 measurements are relevant to sensing operation in accordance with the present disclosure: UE Rx-Tx time difference; gNB Rx-Tx time difference, DL positioning reference signal (PRS) reference signal received path power (RSRPP), UL sounding reference signal (SRS) RSRPP.

The UE Rx-Tx time difference is defined as TUE-RX−TUE-TX, where TuE-Rx is the UE received timing of the DL subframe #i from a Transmission Point (TP), defined by the first detected path in time, and where T_{UE-TX} is the UE transmit timing of a uplink (UL) subframe #j that is closest in time to the subframe #i received from the TP. Note that multiple DL PRS or channel state information reference signals (CSI-RS) for tracking resources, as instructed by higher layers, can be used to determine the start of one subframe of the first arrival path of the TP.

For frequency range #1 (FR1), the reference point for T_{UE-RX} measurement is the Rx antenna connector of the UE and the reference point for T_{UE-TX} measurement is the Tx antenna connector of the UE. For frequency range #2 (FR2), the reference point for TUE-Rx measurement is the Rx antenna of the UE and the reference point for T_{UE-TX} measurement is the Tx antenna of the UE. The UE Rx-Tx time difference is applicable to a UE in the RRC_CONNECTED state and in the RRC_INACTIVE state.

The gNB Rx-Tx time difference is defined as T_{gNB-RX}−T_{gNB-TX}, where T_{gNB-RX} is the Transmission and Reception Point (TRP) received timing of the UL subframe #i containing SRS associated with UE, defined by the first detected path in time, and where T_{gNB-TX} is the TRP transmit timing of the DL subframe #j that is closest in time to the subframe #i received from the UE. Multiple SRS resources can be used to determine the start of one subframe containing SRS.

The reference point for the T_{gNB-RX} shall be: the Rx antenna connector for a type 1-C base station (e.g., as described in 3GPP TS 38.104); the Rx antenna (i.e., the center location of the radiating region of the Rx antenna) for a type 1-0 or 2-0 base station (e.g., as described in 3GPP TS 38.104), or the Rx Transceiver Array Boundary connector for a type 1-H base station (e.g., as described in 3GPP TS 38.104).

Similarly, the reference point for the T_{gNB-TX} shall be: the Tx antenna connector for a type 1-C base station (e.g., as described in 3GPP TS 38.104); the Tx antenna (i.e., the center location of the radiating region of the Tx antenna) for a type 1-0 or 2-0 base station (e.g., as described in 3GPP TS 38.104), or the Tx Transceiver Array Boundary connector for a type 1-H base station (e.g., as described in 3GPP TS 38.104).

The DL PRS-RSRPP is defined as the power of the linear average of the channel response at the i-th path delay of the resource elements that carry DL PRS signal configured for the measurement, where DL PRS-RSRPP for the 1st path delay is the power contribution corresponding to the first detected path in time.

For FR1, the reference point for the DL PRS-RSRPP shall be the antenna connector of the UE. For FR2, DL PRS-RSRPP shall be measured based on the combined signal from antenna elements corresponding to a given receiver branch. The UE Rx-Tx time difference is applicable to a UE in the RRC_CONNECTED state and in the RRC_INACTIVE state.

The UL SRS-RSRPP is defined as the power of the linear average of the channel response at the i-th path delay of the resource elements that carry the received UL SRS signal configured for the measurement, where UL SRS-RSRPP for 1st path delay is the power contribution corresponding to the first detected path in time.

The reference point for UL SRS-RSRPP shall be: the Rx antenna connector for a type 1-C base station (e.g., as described in 3GPP TS 38.104); based on the combined signal from antenna elements corresponding to a given receiver branch for a type 1-0 or 2-0 base station (e.g., as described in 3GPP TS 38.104), or the Rx Transceiver Array Boundary connector for a type 1-H base station (e.g., as described in 3GPP TS 38.104).

For FR1 and FR2, if receiver diversity is in use by the gNB for UL SRS-RSRPP measurements, then: 1) The reported UL SRS-RSRPP value for the first and additional paths shall be provided for the same receiver branch(es) as applied for UL SRS reference signal received power (SRS-RSRP) measurements, or 2) The reported UL SRS-RSRPP value for the first path shall not be lower than the corresponding UL SRS-RSRPP for the first path of any of the individual receiver branches and the reported UL SRS-RSRPP for the additional paths shall be provided for the same receiver branch(es) as applied UL SRS-RSRPP for the first path.

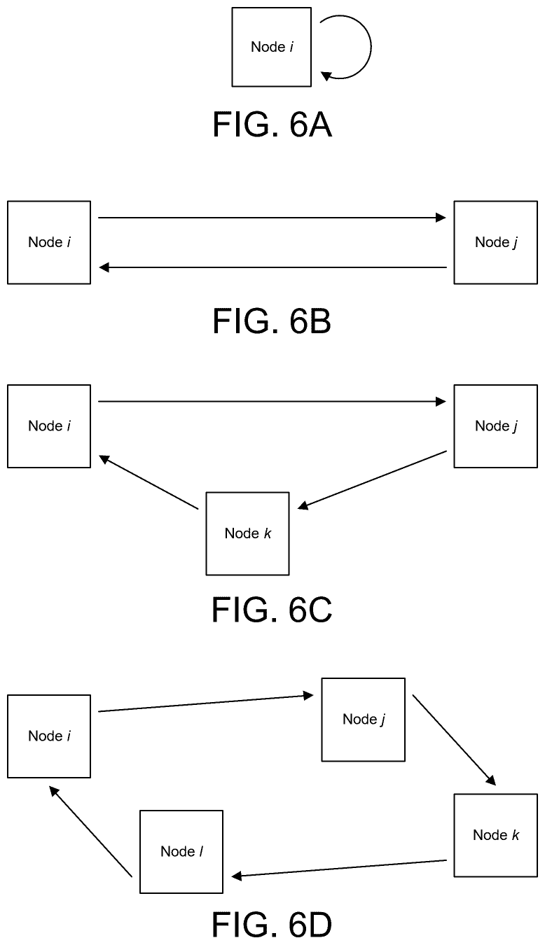

FIGS. 6A-6D illustrate various examples of a circular directed graph for sensing measurements, in accordance with aspects of the present disclosure.

FIG. 6A depicts a first example of a circular directed graph of measurement nodes comprising a single radio node, denoted “Node i”. Here, the circular directed graph comprises one vertex (i.e., the Node i) and comprises one edge for which the Node i may perform a sensing measurement via a sensing signal it transmits (e.g., when operating in full-duplex mode).

FIG. 6B depicts a second example of a circular directed graph of measurement nodes comprising a two radio nodes, denoted “Node i” and “Node j”. Here, the circular directed graph comprises two vertices (i.e., the Node i and the Node j) and comprises two edges for which the Node j may perform a sensing measurement via a sensing signal transmitted by the Node i, and the Node i may perform a sensing measurement via a sensing signal transmitted by the Node j.

FIG. 6C depicts a third example of a circular directed graph of measurement nodes comprising a three radio nodes, denoted “Node i” and “Node j” and “Node k”. Here, the circular directed graph comprises three vertices (i.e., the Node i, the Node j, and the Node k) and comprises three edges for which the Node j may perform a sensing measurement via a sensing signal transmitted by the Node i, the Node k may perform a sensing measurement via a sensing signal transmitted by the Node j, and the Node i may perform a sensing measurement via a sensing signal transmitted by the Node k.

FIG. 6D depicts a fourth example of a circular directed graph of measurement nodes comprising a three radio nodes, denoted “Node i” and “Node j” and “Node k” and “Node l”. Here, the circular directed graph comprises four vertices (i.e., the Node i, the Node j, the Node k, and the Node l) and comprises four edges for which the Node j may perform a sensing measurement via a sensing signal transmitted by the Node i, the Node k may perform a sensing measurement via a sensing signal transmitted by the Node j, and the Node l may perform a sensing measurement via a sensing signal transmitted by the Node k., and the Node i may perform a sensing measurement via a sensing signal transmitted by the Node l.

More generally, let [symbol] =( [symbol] , [symbol] ) be a directed graph of the measurements, such that [symbol] includes the radio nodes participating in the radio sensing measurement procedure (i.e., the sensing Tx and sensing Rx measurement nodes) and constituting the vertices of the graph, and [symbol] (as defined before) includes pair of (i,j) of measurement nodes constituting an edge with direction from i to j, for which the node j may perform a measurement (as sensing Rx node) based on a sensing signal transmitted by the node i (as sensing Tx node). Furthermore, let [symbol] =( [symbol] , [symbol] )⊂ [symbol] denote a circular directed graph as a part of [symbol] wherein the in-degree and out-degree of each vertex is equal to one and wherein the vertices of the graph [symbol] are all connected directly or indirectly by means of a sequence of directed edges.

Examples of the circular directed graph of the measurement nodes are depicted in FIGS. 6A-6D, where the wherein the Node i, the Node j, the Node k, and the Node l are measurement radio nodes (sensing Tx and/or sensing Rx nodes) and the depicted arrows are the edges of the graph [symbol] .

It is observed that the impact of constant mismatches (during the measurement period) of time, frequency and array orientation cancel out for the summation of measurements collected over edges of a circular directed graph. In particular, the summation of measurement can be expressed as:

$$∀ {c}_{} C : {Δ}_{F , ij} = 0 , {Δ}_{T , ij} = 0. \qquad Eq . 10$$

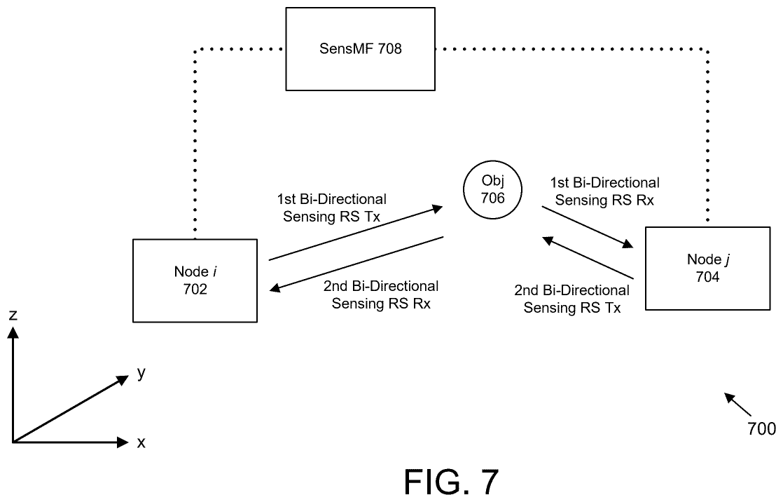

FIG. 7 illustrates an exemplary scenario 700 of bi-directional sensing measurement over an object/area of interest by measurement nodes in communication with a sensing controller entity/function (SensMF) 708. FIG. 7 depicts a first measurement node, Node i 702, a second measurement node, Node i 702, and a target object 706. Here, the measurement nodes Node i 702 and Node j 704 form a circular directed graph, as described above. In various embodiments, the bi-directional sensing measurement is coordinated/controlled by a SensMF 1110, which may be a network entity (e.g., SF or serving gNB) or by a controlling/configuring UE, as described above.

The Node i 702 transmits a first sensing RS (i.e., corresponding to a first measurement path), which sensing RS is received and measured by the Node j 704. Additionally, the Node j 704 transmits a second sensing RS (i.e., corresponding to a second measurement path), which sensing RS is received and measured by the Node i 702.

By relying on the summation of the measurement paths between (i, j) and (j, i), the error bound of the loss function is reduced, considering the ToF measurements, which error bound can be expressed as:

$$Error = \{ {W}_{T} {‖ T \tilde{o} {F}_{j} ( {p}_{obj} , {p}_{i} , t ) + T \tilde{o} {F}_{i} ( {p}_{obj} , {p}_{j} , t ) - ToF ( {p}_{obj} , {p}_{i} , {p}_{j} ) - ToF ( {p}_{obj} , {p}_{j} , {p}_{i} ) ‖}_{2}^{2} \} \geq \{ {W}_{T} {‖ + {n}_{T , j} ( t ) + {n}_{T , i} ( t ) ‖}_{2}^{2} \} \qquad Eq . 11$$

Similarly, relying on the summation of the measurement paths between (i, j) and (j, i) reduces the error bound of the loss function when considering the doppler shift measurements, which error bound can be expressed as:

$$Error = \{ {W}_{D} {‖ {\tilde{f}}_{D , j} ( {p}_{obj} , {v}_{obj} , {p}_{i} , {v}_{i} , t ) + {\tilde{f}}_{D , i} ( {p}_{obj} , {v}_{obj} , {p}_{j} , {v}_{j} , t ) - {f}_{D} ( {p}_{obj} , {v}_{obj} , {p}_{i} , {v}_{i} , {p}_{j} , {v}_{j} ) - {f}_{D} ( {p}_{obj} , {v}_{obj} , {p}_{j} , {v}_{j} , {p}_{i} , {v}_{i} ) ‖}_{2}^{2} \} \geq \{ {W}_{D} {‖ + {n}_{D , j} ( t ) + {n}_{D , i} ( t ) ‖}_{2}^{2} \} \qquad Eq . 12$$

The above observation provides a concept to counteract the impact of unknown but constant synchronization mismatches for sensing and/or positioning measurements within a wireless network.

It is understood that this disclosure is not limited to any of the single example/solution/embodiment or implementation elements individually, and one or more elements of the above-mentioned may be combined to construct a new embodiment.

According to embodiments of a first solution, a SensMF discovers and/or selects and configures a first group of nodes for performing sensing signal transmission and sensing signal reception and measurements, wherein each configured sensing measurement is associated with a pair of a sensing transmitter and a sensing receiver nodes such that the configured sensing measurements and the configured sensing nodes of the group constitute a circular directed graph of sensing measurements (i.e., as defined above).

As such, the sensing information/results (e.g., presence of an object, position of a sensing target etc.) is obtained and/or derived by the SensMF based on, at least in part, a combined sensing measurement over the circular directed graph of measurements. More specifically, the combined sensing measurement may include the arithmetic summation of the measurement values corresponding to the directional edges of the circular directed graph.

In one example of the first solution, the circular directed graph of sensing measurements comprising two sensing nodes and two sensing measurements (e.g., as exemplified by FIG. 6B), and wherein the combined sensing measurements includes arithmetic summation of the measurement values.

In one example of the first solution, the circular directed graph of sensing measurements comprising three sensing nodes and three sensing measurements (e.g., as exemplified by FIG. 6C), and wherein the combined sensing measurements includes arithmetic summation of the measurement values.

In one example of the first solution, the circular directed graph of sensing measurements comprising four sensing nodes and four sensing measurements (as exemplified by FIG. 6D), and wherein the combined sensing measurements includes arithmetic summation of the measurement values.

In some embodiments, the sensing measurement of a sensing node comprises an identification of one or multiple paths associated with a sensing target and/or a sensing target area of interest. Note that the path identification is useful for tracking or when not all the measurements are reported, and hence a measurement node can better establish if a measurement of a path is associated with a target, e.g., by observing some pattern, such as a “house” shape, and then further reporting its characteristics.

In the case of the combining of sensing measurements, it is important that measurements are first associated with a target/pattern and then combined. Without first associating the sensing measurements with a target/pattern, different path measurements could be conflated, resulting in a situation where a path measurement of an object A is combined with a path measurement of an object B (different object), thereby introducing measurement error.

In some embodiments, the identification of a path associated with a sensing target or target area of interest is performed by the sensing node according to a description of the path that is indicated (e.g., by the SensMF to the measurement node) or is known (e.g., via the application information of a UE).

In one embodiment, a path is identified according to its propagation time/delay characteristics, e.g., propagation delay of the path according to a known time reference by the sensing node (e.g., a global or a local clock or time reference, or a time reference generated from another local measurement, e.g., reception time of another known signal).

In another embodiment, a path is identified according to the propagation path direction, e.g., reflection point position information according to a known coordinate system or location reference by the node or angular information [AoA, ZoA] according to a known coordinate system at the sensing node or according to a known reference direction at the sensing node (e.g., according to a reception angle of another known signal).

In another embodiment, a path is identified according to the movement/mobility pattern associated with the propagation path, e.g., doppler frequency shift/difference of the path compared to a known frequency reference at the sensing node (e.g., according to another received signal or another measured path at the node) or according to a known doppler frequency/frequency shift of another path or measurement available at the sensing node.

In another embodiment, a path is identified according to the energy/power associated with the propagation path, e.g., RSRPP of the path or sum-RSRPP of group of paths associated with the target/target area.

In another embodiment, a path is identified according to pattern describing a group of paths wherein the path is a member of the group of paths, e.g., the collection of paths reflected from an object with a known size/shape/RCS characteristic, indication that the path will be part of a group of paths with an indicated angular spread at the receiver, or reflected from a target of an indicated shape/size/RCS value.

In another embodiment, a path is identified according to an indication of a previously measured or identified path (e.g., a reported path measurement ID) or object (an object ID) or object type (e.g., a human). Moreover, the path may be identified according to any combination of the above.

In some embodiments of the first solution, the description of the target (or a subset thereof) may be communicated via sending an index from a known codebook to the sensing measurement node, wherein the codebook includes different possible target types, patterns of path delay/doppler/angle margins, etc. As an example, the codebook may encode a propagation delay of [1-3 nsec], and/or a doppler shift of [20-40 Hz], and/or an AoA of [20-40 degrees] according to a known coordinate system and/or a reference of time, frequency, etc., at the receiver.

In some embodiments, the reporting of a measurement performed over an identified path by a sensing measurement node to the SensMF may further accompany an indication of the associated target/target area, e.g., a label. Note that the label may be needed to perform measurement configuration over the circular directed graph. The indication/label may assist the SensMF to track the path modifications over time. Examples of the indication include, but are not limited to, an object identifier (ID), a path ID, path group ID accompanied with an RSRPP measurement of a path associated with the indicated object ID or path group ID.

In some embodiments, a sensing measurement and/or sensing signal transmission configuration of a node is defined with dependency to a previously performed sensing measurement. As such, one or multiple or a subset of the configuration parameters for sensing measurement and/or sensing signal transmission or reception of a sensing node may be determined by the sensing node (or indicated implicitly by the SensMF) based on one or multiple parameters obtained/estimated by the sensing node from the previous one or multiple measurements. In other words, the configuration parameters for a subsequent sensing signal transmission may be dependent upon configuration parameters for a prior measurement, thereby a sensing signal reception and measurement configuration may implicitly indicate one or more transmission parameters for the subsequent sensing signal transmission.

In one example of the above, a sensing node may receive a first sensing signal from a sensing transmitter node, and estimate the direction of arrival (AoA, ZoA) of the path associated with a target. Subsequently, the sensing node transmits a second sensing signal, according to a configuration received by the SensMF and A) utilizing a beam corresponding to the estimated AoA, ZoA of the first sensing signal, or B) choosing a time-reference for transmission of a second sensing signal according to an estimated time of arrival of the sensing signal (e.g., transmission will be done at symbol number of s+2 and with the time difference from the start of the symbol according to the estimated time of arrival of the first sensing signal), or C) choosing a frequency shift for transmission of a second sensing signal (e.g., in form of a time-dependent phase rotation of the transmitted symbols within the second sensing signal) according to an estimated doppler shift of the first sensing signal, or D) a combination thereof.

In some embodiments, the discovery and/or selection of a group of sensing nodes and sensing measurements associated with a circular directed graph of sensing measurements further comprise discovery and determination, by the SensMF, an initial group of sensing nodes and an associated set of sensing signal transmissions and measurements. Let the initial set of sensing nodes and sensing measurements be mapped to an initial directed graph, [symbol] =( [symbol] , [symbol] ), and wherein [symbol] =( [symbol] , [symbol] )∈ [symbol] , ∇c ∈ [symbol] , [symbol] being the index set of constructed circular directed graphs of a SensMF. In other words, different topologies of a circular directed graph that can be constructed by the SensMF from an initial group of nodes/measurements.

In some embodiments, one or multiple of the following arrangements hold:

In one embodiment, [symbol] ∩ [symbol] =ø, ∇c1≠c2∈ [symbol] , e.g., the sensing nodes of the constructed different circular directed graphs are disjoint, different circular graphs are built by utilizing a disjoint set of sensing nodes.

In one embodiment, [symbol] ∩ [symbol] ≠ø, ∃c1, c2∈ [symbol] , e.g., a sensing node may simultaneously belong to two or more of the constructed circular directed graphs of the SensMF. In one example, a sensing node is configured for transmission (reception/measurement) of a first sensing signal for a first circular directed graph and is configured for transmission (reception/measurement) of a second sensing signal for a second circular directed graph. In another example, a sensing node is configured for transmission of a sensing signal utilized (e.g., via measurement by a seme or different sensing receiver nodes) at two different circular directed graphs.

In one embodiment, [symbol] ∩ [symbol] =ø, ∇c1, c2∈ [symbol] , e.g., the sensing measurements of the constructed different circular directed graphs are disjoint, different circular graphs are built by configuring separate (disjoint) sensing measurements. In some examples, this includes utilizing the same or partially the same sensing nodes by two circular directed graphs, but separately performing/collecting sensing measurements (e.g., by utilizing separate sensing signals among different circular directed graphs).

In one embodiment, [symbol] ∩ [symbol] ≠ø, ∃c1, c2∈ [symbol] , e.g., a sensing measurement (determined according to a configure a sensing transmitter node, a sensing receiver node, a sensing signal, and sensing measurement type) may be utilized simultaneously by at least two circular directed graphs.

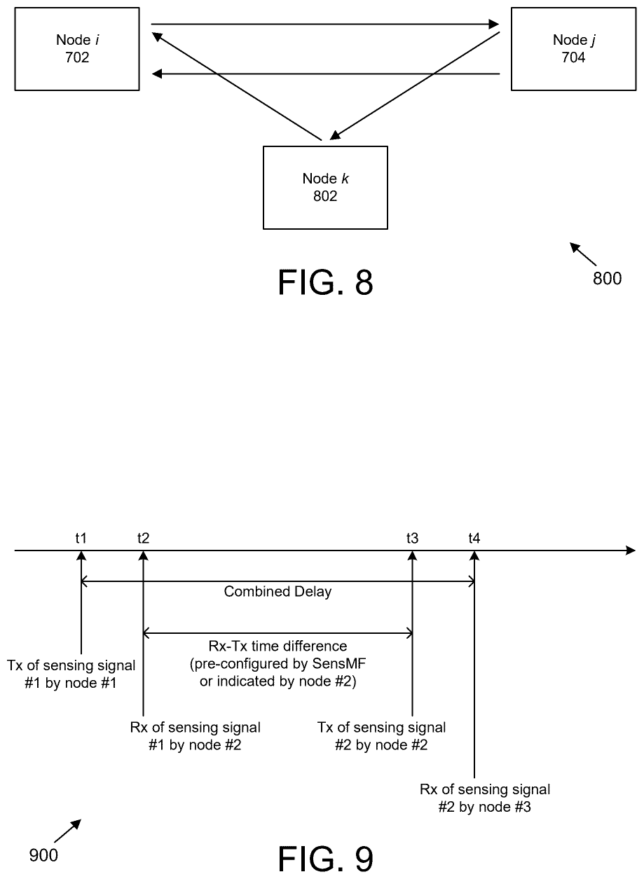

FIG. 8 illustrates an exemplary arrangement 800 of two circular directed graphs of measurement nodes, one comprised of the Node i 702 and the Node j 704 (e.g., a bi-directional sensing measurement arrangement) and another comprised of the Node i 702, the Node j 704, and the Node k 802. Note that Node i 702 and Node j 704 are common nodes among the two circular directed graphs, and the measurement (i,j) is a common measurement to the both graphs. In other words, the two circular directed graphs share two vertices and a common edge.

In some embodiments, a sensing measurement corresponding to an edge of the circular directed graph of sensing measurements is reported to the SensMF by the sensing node performing the measurement corresponding to the edge (e.g., by the node j for a measurement corresponding to the edge (i,j)). In such embodiments, the sensing node may report a single measurement or a combined measurement to the SensMF.

Regarding the combined measurements, in some embodiments, the combined measurements over the edges of a circular directed graph include: A) a round-trip propagation time of the identified sensing paths over the edges of the circular directed graph (e.g., the incurred total time delay as a result of the sensing signal propagation from paths associated with the sensing target from the transmitter nodes to the corresponding receiver nodes of the measurements within a circular directed graph); B) a round trip doppler shift over the identified sensing paths of the edges of the circular directed graph (e.g., the incurred total doppler shift as a result of the sensing signal propagation from a path associated with the sensing target from the transmitter nodes to the corresponding receiver nodes of the measurements within a circular directed graph target); C) total received power of the identified sensing paths over the edges of the circular directed graph; or combinations thereof.

In some other embodiments, a sensing measurement corresponding to an edge of the circular directed graph of sensing measurements is combined with other sensing measurements (corresponding to one or more of the other edges of the circular directed graph of sensing measurements) at a reporting node (one of the sensing nodes of the graph or an external node to the graph) and the combined measurement is reported to the SensMF. In one embodiment, the measurements of different edges of the graph are sent to the reporting node and then combined at the reporting node. In another embodiment, the reporting node is a sensing node, and the sensing measurement of the sensing node is configured to be an aggregate measurement (i.e., an implicit combination of multiple measurements) of the sensing measurements associated with multiple edges.

In one such implementation, a first sensing node is configured to transmit a configured first sensing signal (e.g., an RS known to the sensing Rx node corresponding to the same edge of the measurement graph) and a second sensing node is configured to measure the Time-of-Arrival (ToA) (and/or doppler shift) of the first sensing signal and transmit a second RS after an indicated time (e.g., an indicated Rx-Tx time difference for the sensing node) (or after performing an indicated frequency shift as the estimated doppler shift combined with an indicated constant frequency shift).

Moreover, a third sensing node may be configured to receive and measure the ToA (and/or doppler shift) of the second RS. In this case, the ToA (doppler shift estimate) reading of the second sensing Rx node differs from the transmission time instance of the first RS with a combined ToF of measurement paths between the first sensing node to the second sensing node, and the second sensing node to the third sensing node and the indicated Rx-Tx time difference of the second sensing node (or the combined doppler shift of the paths and the indicated constant frequency shift).

FIG. 9 illustrates an exemplary timeline 900 showing an implicit measurement combination, in accordance with aspects of the present disclosure. The timeline 900 corresponds to a circular directed graph comprising at least three nodes. At time t1, a first node (node #1) transmits a first sensing signal (signal #1) and at time t2, a second node (node #2) receives the first sensing signal. The time difference between t2 and t1 is the time-of-flight (ToF) associated with a propagation path between node #1 and node #2.

At time t3, the second node (node #2) transmits a second sensing signal (signal #2) and at time t4, a third node (node #3) receives the second sensing signal. The time difference between t4 and t3 is the time-of-flight (ToF) associated with a propagation path between node #2 and node #3. Additionally, the time difference between t3 and t2 is the Rx-Tx time difference. Note that the combined delay (i.e., the time difference between t4 and t1) is embedded in the reception time of the sensing signal at the node #3.

In some embodiments, any of the configurations (of a sensing signal, a sensing transmission, sensing reception, sensing measurement) and/or indications and/or reporting information elements (IEs) between a sensing node and the SensMF or a subset thereof are: A) received by the sensing Rx nodes, B) transmitted by the sensing Rx nodes, C) received by the sensing Tx nodes, D) transmitted by the sensing Tx nodes, E) transmitted and/or received by the SensMF node, or F) any combination thereof.

In some embodiments, the above configurations, indication, and/or reporting IEs may be communicated via the UL, DL or sidelink (SL) physical data and/or control channels defined within the communication network, e.g., NR physical broadcast channel (PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH), via a higher layer (e.g., MAC control element (MAC-CE) or RRC) signaling, wherein the sensing Rx and/or the sensing Tx node is a UE.

In some embodiments, the above configurations, indication, and/or reporting IEs may be communicated via a logical interface between the SF and the Sensing nodes, as part of the LTE Positioning Protocol (LPP) (or as modified/enhanced LPP message framework for sensing) or as an interface defined for sensing message exchanges over the N1 interface between the SF and a UE, wherein the sensing Tx and/or sensing Rx node is a UE.

In some embodiments, the above configurations, indication, and/or reporting IEs may be communicated via a logical interface between the SensMF and the Sensing nodes, as part of the NR Positioning Protocol Annex (NRPPa) (or modified/enhanced NRPPa message framework for sensing) or as an interface defined over the Next Generation Application Protocol (NGAP) interface, wherein the sensing Tx and/or sensing Rx node is a TRP of RAN and the SensMF is a core network function (SF, LMF, etc.).

In some embodiments, the above configurations, indication, and/or reporting IEs may be communicated via a logical interface between the SensMF and the Sensing nodes, wherein the SensMF is a serving gNB of a sensing task and the sensing node is a UE or a TRP of RAN. In some examples, the interface utilizes (at least in part) the X2 interface between the associated gNB of the sensing node and the serving gNB of the sensing task.

According to embodiments of a second solution, upon reception of a sensing task/information request from a sensing service/information consumer (including description of a sensing target/area to be sensed, area of interest for sensing, type of sensing, a sensing event and reporting time pattern description, etc.), a SF (e.g., a sensing-dedicated network function or enhanced LMF with sensing capabilities) discovers and selects a serving gNB for the received sensing task requested by the consumer. Furthermore, the SF and/or the selected Serving gNB of the sensing task identify one or multiple TRPs (e.g., belonging to other neighboring gNBs, TRPs with related sensing capabilities of the sensing task) and at least one UE for performing sensing transmission, sensing reception and measurements and reporting, or a combination thereof.

As such, the at least one UE node is configured (e.g., by the SF via LPP/enhanced LPP for sensing or a logical interface over N1 for sensing and/or by the serving gNB of the sensing task via a message contained in PDSCH/PDCCH physical channel) for sensing signal transmission in the UL, sensing signal reception in DL, sensing measurement based on the received DL sensing signal, and sensing measurement reporting (e.g., via PUSCH or PUCCH, to the serving gNB or via LPP/enhanced LPP or a logical interfaced defined over N1 interface to the SensMF), and furthermore the neighboring TRPs are configured (e.g., by the SF via NRPPa/enhanced-NRPPa for sensing or a logical interface over NGAP/N2 interface or a new interface N-x dedicated for connection of SF and the RAN node and/or by the serving gNB of the sensing task, e.g., via a message contained in the X2 interface) for sensing signal transmission in the DL, sensing signal reception in the UL or in the TRP-TRP air interface, sensing measurement, and sensing measurement reporting (to the serving gNB of the sensing task and/or to the SF) and wherein the sensing results (the requested/intended sensing information of the associated sensing task) is obtained by the serving gNB of the sensing task or by the SF, at least in part, based on the collected and combined sensing measurements in the UL (reported by the TRPs) and in the DL (reported by the UEs).

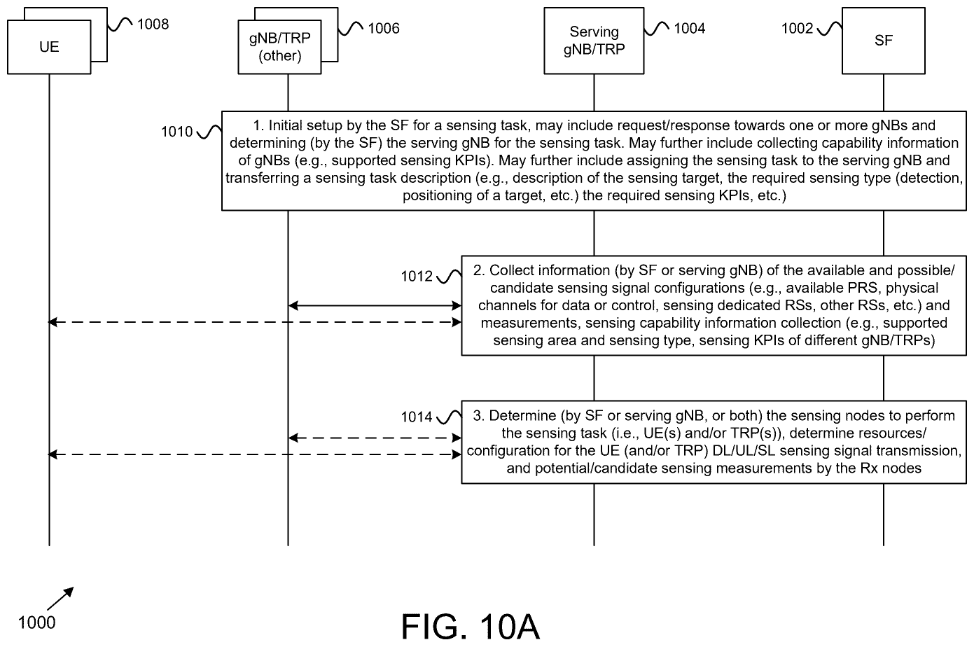

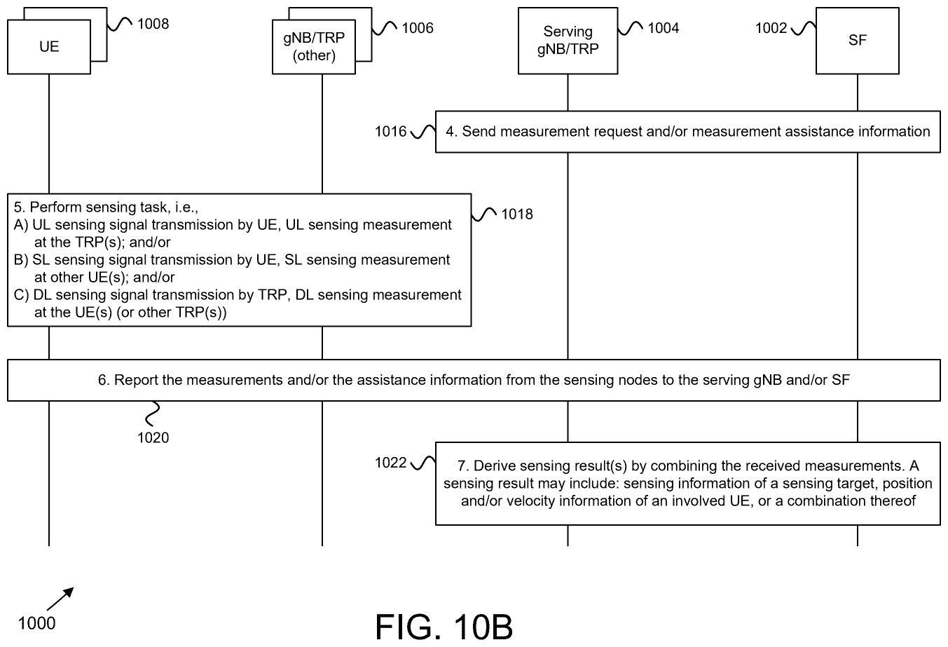

A high-level procedure is shown in FIGS. 10A and 10B, where the multiple reciprocal DL and UP measurements can be combined. Note that the second solution describes a Round-Trip Time (RTT)-based sensing procedure with participation of one or multiple UEs. Nevertheless, it is understood that elements of this embodiment can be as well serve for an RTT based sensing procedure among one or multiple TRPs/RAN nodes without presence of a UE, and wherein the described IE exchanges to or from a UE can be applicable for the IE exchanges to or from a sensing Tx-Rx node (e.g., a gNB TRP) configured/controlled by a SensMF.

FIGS. 10A and 10B illustrate a procedure 1000 for UE-assisted Multi-RTT sensing, in accordance with aspects of the present disclosure. The procedure 1000 involves a SF 1002, a serving gNB/TRP 1004 (i.e., serving with respect to the sensing task), one or more additional gNB/TRPs 1006, and one or more UEs 1008. Note that the SF 1002 may be a SensMF as described in the present disclosure.

Beginning at FIG. 10A, at Step 1, the SF performs the initial setup by for a sensing task (see block 1010). The initial setup may include communicating request/response towards one or more gNBs and determining (by the SF) the serving gNB 1004 for the sensing task. In some embodiments, the initial setup may further include collecting capability information of gNBs (e.g., supported sensing KPIs). In certain embodiments, the initial setup may further include assigning the sensing task to the serving gNB and transferring a sensing task description (e.g., description of the sensing target, the required sensing type (detection, positioning of a target, etc.) the required sensing KPIs, etc.).

In some embodiments, a serving gNB 1004 of a sensing task or a candidate gNB (for becoming a serving gNB 1004 of the sensing task), indicates to the SF 1002 its supported sensing techniques (e.g., if the gNB supports the UE assisted sensing, support of the UE assisted RTT-based sensing technique, Round-Trip Doppler shift (RTD)-based sensing technique). In certain embodiments, the serving gNB 1004 (or candidate gNB) autonomously indicates its supported sensing techniques. In other embodiments, the serving gNB 1004 (or candidate gNB) indicates its supported sensing techniques upon request by the SF 1002.

At Step 2, the SF 1002 (or serving gNB 1004) collects information of the available and possible/candidate sensing signal configurations (e.g., available PRS, physical channels for data or control, sensing dedicated RSs, other RSs, etc.) and measurements, sensing capability information collection (e.g., supported sensing area and sensing type, sensing KPIs of different gNB/TRPs) (see block 1012).

At Step 3, the SF 1002 (or serving gNB 1004, or both) determines the sensing nodes to perform the sensing task (i.e., UE(s) 1008 and/or other gNB TRP(s) 1006) (see block 1014). Additionally, the SF 1002 (or serving gNB 1004, or both) determines the resources/configuration for the UE(s) 1008 (and/or the other gNB/TRP(s) 1006), e.g., DL/UL/SL sensing signal transmission, and potential/candidate sensing measurements by the Rx nodes.

In some embodiments, the serving gNB 1004 of a sensing task is the same gNB as the serving gNB of the one or more UEs participating in the RTT-based sensing measurement process.

Continuing at FIG. 10B, at Step 4 the SF 1002 (or serving gNB 1004, or both) transmits measurement request and/or measurement assistance information to the selected UE(s) 1008 and/or other gNB TRP(s) 1006 (see block 1016).

At Step 5, the UE(s) 1008 and/or other gNB TRP(s) 1006 perform the sensing task (see block 1018). For example, the sensing task may include one or more of: A) UL sensing signal transmission by UE, UL sensing measurement at the TRP(s); and/or B) SL sensing signal transmission by UE, SL sensing measurement at other UE(s); and/or C) DL sensing signal transmission by TRP, DL sensing measurement at the UE(s) (or other TRP(s)).

At Step 6, the UE(s) 1008 and/or other gNB TRP(s) 1006 report the measurements and/or the assistance information from the sensing nodes to the serving gNB 1004 and/or SF 1002 (see block 1020).

At Step 7, the SF 1002 (or serving gNB 1004, or both) derives sensing result(s) by combining the received measurements (see block 1022). A sensing result may include one or more of: A) sensing information of a sensing target, B) position and/or velocity information of an involved UE, or C) a combination thereof.

In some embodiments, the SF 1002 and the serving gNB 1004 of the sensing task are co-located and/or part of a same node/entity. In some embodiments, all or part of the messages described to be received by the SF 1002 are received by the serving gNB 1004 of the sensing task.

In some embodiments, communications of the SensMF/SF with the gNB/TRP nodes further includes the activation and/or de-activation of the sensing signal transmission (e.g., for a configured UL SRS resource).

It is understood that within this disclosure, the term capability is interpreted as any supported feature, measurement type, measurement parameter, supported radio parameter/operation, processing type/power, for any of the sensing nodes (e.g., UE and/or TRP sensing capabilities).

In some embodiments, the sensing measurement configuration comprises a sensing path/target description, wherein the description of the at least one sensing path is shared/similar among the DL sensing measurement at a UE and an UL sensing measurement at a gNB/TRP. In such embodiments, the path description is shared among UL and DL measurement nodes of the multi-RTT, and not just for LoS cases. In certain embodiments, the path description may include indication of a LoS or a first arrival path. In some other embodiments, the path description may include a delay margin (e.g., a delay within [t1 t2] margin/range), an angular margin, a doppler shift margin, or an energy/RSRPP pattern/margin to which a propagation path associated with a sensing target is compliant.

In some embodiments, the common information elements (e.g., for the above embodiment) are communicated via a group-common signaling (e.g., towards a group of UEs via a downlink control information (DCI) message with cyclic redundancy check (CRC) scrambled via group common radio network temporary identifier (RNTI), or information embedded within a broadcast message, e.g., master information block (MIB), or system information block (SIB), or PBCH message).

In some embodiments, the information listed in Table 1 may be transferred from the SF or from the serving gNB of a sensing task to the UL.

TABLE 1
Assistance data that may be transferred from SF/Serv. gNB to the UE
Information

Physical cell IDs (PCIs), global cell IDs (GCIs), and RS IDs (e.g., PRS, CSI-RS, sensing dedicated
RS), Absolute Radio Frequency Channel Numbers (ARFCNs) of candidate NR TRPs for
measurement
Timing relative to the serving (reference) TRP of candidate NR TRPs
Sensing signal configuration of candidate NR TRPs, e.g., DL-PRS, CSI-RS, signals containing
unknown sequence of data/RS (e.g., portion of PDSCH transmitted by a TRP illuminating a sensing
target area)
SSB information of the TRPs (the time/frequency occupancy of SSBs)
PRS-only and/or sensing signal-only TP indication
On-Demand sensing signal/DL-PRS-Configurations
Validity Area of the Assistance Data with respect to a UE position, with respect to a sensing target
position/area or a combination thereof
A sensing target path-group description one or more criteria according to which a detected path at
the UE shall be identified to belong to a group of paths associated with a sensing target. A target
description may include, e.g., a path condition in delay/AoA/ZoA/doppler shift range (or a
combination thereof) and may include a difference indication (of the paths with an RSRPP reading
above a threshold among two time instances/windows)
Conditional path measurement description: conditions over which a path measurement shall be
conducted and/or reported by the UE and may include, e.g., an RSRPP value above a threshold,
AoA/ZoA angular range of path reception by the UE according to a global or a known/local
coordinate system by the UE,
Relative path measurement description/configuration: description of a requested path measurement
relative to a previously conducted/known measurement at the UE (e.g., difference of RSRPP of the
path associated with a sensing target to a measurement reading at an earlier measurement instance
of the same path, detecting a path within an indicated delay/doppler/angle range based on the
measured RSRPP exceeds (is lower than) a corresponding RSRPP with an indicated threshold of a
previous measurement instance (previous time instance) of the same path)
Transmission configuration adjustments: adjustment of the sensing signal transmission parameters
according to the outcome of a conducted/configured measurement, e.g., utilizing the beam in the
direction of the previously detected path (of a sensing target) for sensing signal transmission
Reception configuration adjustments: adjustment of the sensing signal reception parameters
according to the outcome of a conducted/configured measurement, e.g., utilizing the beam in the
direction of the previously detected path (of a sensing target) for sensing signal reception

In some embodiments, the information listed in Table 2 may be signaled from UE to the SF (e.g., when SF performs aggregation of the sensing measurements for deriving the sensing results) or to the serving gNB of an associated sensing task (e.g., when serving gNB of the sensing task performs aggregation of the sensing measurements for deriving the sensing results or when the SF performs aggregation of the sensing measurements and the serving gNB later transfers the collected measurements (or a processed version thereof) to the SF).

TABLE 2
Measurement results that may be transferred from UE to the SF/Serv. gNB of a
sensing task
Information

PCI, GCI, and RS (e.g., PRS) ID, ARFCN, RS (e.g., PRS) resource ID, RS (e.g., PRS) resource set
ID for each measurement, physical channel resource pattern/ID used for sensing, e.g., when a
sensing measurement is obtained based on the part of PDSCH containing data (not only RS)
DL-RS (e.g., PRS, sensing RS, CSI-RS) reference signal received power (RSRP) measurement
UE Rx-Tx time difference measurement
Time stamp of the measurement
Quality for each measurement
TA offset used by UE
UE Rx Timing Error Group (TEG) IDs, UE Tx TEG IDs, and UE RxTx TEG IDs associated with
UE measurements, e.g., Rx-Tx time difference measurements, doppler shift measurements, an RS
ToA measurement
LoS/NLOS information for UE measurements
DL-RS (e.g., PRS, sensing RS, CSI-RS) reference signal received path power (RSRPP)
measurement
The association of UE Tx TEG ID and RS (e.g., SRS )
Sensing measurements, e.g., including the configured conditional and/or relative RSRPP
measurement (e.g., difference of an RSRPP reading of a path in a second time window/instance
within a specific AoA/ZoA margin, relative to a previous reading of the same path within a first
time instance/window).
A measured AoA/ZoA information of a path
A measured doppler shift of a path
The time window/resources used for measurement, e.g., of the doppler shift
A path group associated with a measurement, e.g., indicating or labelling a path RSRPP and
doppler shift is associated with an indicated sensing target/target area
UE position (when available)

In some embodiments, the UL Rx-Tx time difference measurement includes the measured time difference between the UL reception of a subframe containing the DL sensing signal and the transmission of the configured UL sensing signal by the UL. In some embodiments, UL Rx-Tx time difference is measured based on the reception time of the first path containing the configured DL sensing signal. In some other embodiments, UL Rx-Tx time difference is measured based on the reception time of the path associated with a sensing target, and wherein the path associated with the sensing target is detected by the UE based on the description of the target and/or the criteria/condition of the path parameters (e.g., a condition on the RSRPP of the path, AoA/ZoA ofthe path) received from the SF or the serving gNB of the sensing task. In some embodiments, the Rx-Tx time difference measurements are defined according to the Table 3.

TABLE 3
UE Rx-Tx time difference with a path reference definition

| | |
|---|---|
| Definition | The UE Rx-Tx time difference with reference to an Rx path is defined as: |
| | T_{UE-RX} (Rx Path)-T_{UE-TX} |
| | Where: |
| | T_{UE-RX} (Rx Path) is the UE received timing of the DL subframe #i from a Transmission |
| | Point (TP), defined by the detected path (Rx Path) and wherein the Rx Path may be |
| | defined in association with a sensing target or a as an arrived path number ordered |
| | according to the path strength (RSRPP) path arrival time (e.g., first/second arrival path), |
| | doppler shift (path presenting the largest doppler frequency shift). |
| | T_{UE-TX} is the UE transmit timing of the UL subframe #j that is closest in time to the |
| | subframe #i received from the TP. |
| Applicable | RRC_CONNECTED, |
| for | RRC_IDLE |
| | RRC_INACTIVE |

In some embodiments, the information listed in Tables 4-6 may be transferred from the gNB (of one or multiple TRPs) to the SF or to the serving gNB of a sensing task to the UL.

In some embodiments, the gNB (of the one or more TRPs participating in the sensing measurement process) is not the serving gNB of the sensing task and transfers the listed IEs to the serving gNB of the sensing task (e.g., via X2 interface) or to the SF (e.g., via a message contained in the N2 or a sensing dedicated interface between the gNB and SF).

In some other embodiments, the gNB is in fact the serving gNB of the sensing task and transfers the listed IEs to the SF (e.g., via NRPPa/enhanced NRPPa for sensing or a message over N2 interface or a dedicated N-x interface between the SF and the gNB), wherein the SF may perform, at least in part, the aggregation of the sensing measurements and deriving sensing results, based on the transferred IEs.

The assistance data that may be transfesied from gNB to SF or to the serving gNB of the sensing task is listed in Table 4.

TABLE 4
Assistance data that may be transferred from gNB to the SF/Serv. gNB
Information

PCI, GCI, ARFCN and TRP IDs of the TRPs served by the gNB
Timing information of TRPs served by the gNB
Sensing signal (e.g., DL-PRS) configuration of the TRPs served by the gNB
SSB information of the TRPs (the time/frequency occupancy of SSBs)
Spatial direction information of the sensing signal resources of the TRPs served by the gNB
Geographical coordinates information of the sensing signal (e.g., DL-PRS) resources of the TRPs
served by the gNB
TRP type
On-demand DL-PRS information
TRP Tx TEG association information
Other sensing data/measurements related to the area (if any), e.g., RSRPP/angle/delay/doppler shift
TRP-TRP measurements or UL/DL measurements associated with a sensing target area, or non-
3GPP sensing data available with related to the desired sensing target/sensing target area
Assistance data related to the available “other sensing data/measurements related to the area”,
e.g., associated UE/TRP position of the other measurements, timing information of the associated
UE/TRP measurements, sensing signal/resource ID of the measurement and association to the TEG
of the associated UE/TRPs
Processed sensing measurements, when the serving gNB of the sensing task receives/collects
sensing measurements from the sensing receivers and generates/derives at least part of the sensing
results (e.g., detection/presence of a sensing target)

The configuration data for a UL that may be transferred from the gNB (e.g., serving or non-serving gNB of a sensing task) to the SF is listed in Table 5.

TABLE 5
UL information/UE configuration data that may be transferred
from serving gNB of the sensing task to the SF
UE configuration data

UE sensing signal transmission (e.g., UL SRS) configuration
System Frame Number (SFN) initialization time for the
sensing signal configuration

The measurement results that may be signaled from gNBs to the SF or signaled from the gNBs to the serving gNB of a sensing task is listed in Table 6.

TABLE 6
Measurement results that may be transferred from gNBs to the SF /Serv. gNB
Measurement results

NE cell global identifier (NCGI) and TRP ID of the measurement
gNB Rx-Tx time difference measurement
UL-SRS (or other sensing signal transmitted by a UE in the UL)-RSRP
UL-SRS (or other sensing signal transmitted by a UE in the UL)-RSRPP (according to an indicated
condition for reporting as conditional RSRPP)
UL Angle of Arrival (azimuth and/or elevation) (i.e., when used with UL-AoA for hybrid
positioning)
Multiple UL Angle of Arrival (azimuth and/or elevation) (i.e., when used with UL-AoA for hybrid
positioning)
SRS Resource Type (i.e., when used with UL-AoA for hybrid positioning)
Time stamp of the measurement
Quality for each measurement
Beam Information of the measurement
LoS/NLOS information for each measurement
Antenna Reference Point (ARP) ID of the measurement
Relative RSRPP measurements of the UL sensing signal
Doppler shift of a path of the UL sensing signal, frequency difference of a signal received from a
path of the UL sensing signal and the transmission frequency of a known/indicated signal (a
configured sensing signal)
A target class/path group/label associated with a measurement
TRP-j to TRP-i RSRPP, AoA, AOD, ZoA, ZoD, doppler shift of a detected path between TRP j and
TRP i (e.g., according to an indicated condition, or association to a sensing target)
If a reported measurement does not correspond to an explicitly configured resource ID, the
resources/time-instance/time-window at which a measurement is generated

In some embodiments, the gNB Rx-Tx time difference measurement includes the measured time difference between the gNB reception of a subframe containing the UL sensing signal and the transmission of the DL sensing signal by the gNB. In some embodiments, gNB Rx-Tx time difference is measured based on the reception time of the first path containing the configured UL sensing signal.

In some other embodiments, gNB Rx-Tx time difference is measured based on the reception time of the path associated with a sensing target, and wherein the path associated with the sensing target is detected by the UE based on the description of the target and/or the criteria/condition of the path parameters (e.g., a condition on the RSRPP of the path, AoA/ZoA of the path) received from the SF or the serving gNB of the sensing task or determined by the gNB. In some embodiments, the Rx-Tx time difference measurements is defined according to the Table 7.

TABLE 7
gNB Rx-Tx time difference with a path reference definition

| | |
|---|---|
| Definition | The gNB Rx-Tx time difference is defined as: |
| | T_{gNB-RX} (Rx Path)-T_{gNB-TX} |
| | Where: |
| | T_{gNB-RX} (Rx Path) is the Transmission and Reception Point (TRP) received timing of the |
| | UL subframe #i containing a sensing signal (e.g., SRS) associated with UE, |
| | corresponding to a detected path (Rx Path) and wherein the Rx Path may be defined in |
| | association with a sensing target or a as an arrived path number ordered according to the |
| | path strength (RSRPP) path arrival time (e.g., first/second arrival path), doppler shift |
| | (path presenting the largest doppler frequency shift). |
| | T_{gNB-TX} is the TRP transmit timing of the DL subframe #j that is closest in time to the |
| | subframe #i received from the UE. |
| | Multiple sensing signal resources can be used to determine the start of one subframe |
| | containing SRS. |

In some embodiments, a gNB Rx-Tx time difference value is indicated to a TRP (by the SF or the serving gNB of the assigned sensing task) according to which the TRP adjusts transmission of the configured DL RS signal (e.g., DL PRS, CSI-RS, sensing RS etc.) according to the received signal timing of an indicated Rx Path and according to the indicated gNB Rx-Tx time difference. Note here that the SensMF uses the IE gNB Rx-Tx time difference to generate a customized delay (not for measurement) in order to implement over-the-air (OTA) delay aggregation. In some embodiments, an additional waiting time is indicated to the TRP for DL sensing signal transmission (by the SF or the serving gNB of the assigned sensing task) such that the transmission of the DL sensing signal is performed after the detected timing of the indicated Rx path in addition to the gNB Rx-Tx time difference and in addition to the further indicated delay (1 subframe, N number of NR symbols within a frame with subcarrier spacing (SCS) x).

In some embodiments, the information listed in Table 8 may be transferred from the SF or from the serving gNB of a sensing task to the gNB (of one or multiple TRPs).

TABLE 8
Requested UL sensing signal transmission characteristics information that may be
transferred from SF/Serv.gNB to gNB.
Information

Number Of Transmissions/duration for which the sensing signal transmission (e.g., UL-SRS) is
requested
One or multiple candidate UEs (e.g., UE IDs) for UL sensing signal transmission or DL sensing
measurements
Information of the one or multiple UEs or candidate UEs participating in sensing measurement
including UE sensing capabilities (observable area, sensing transmission or reception capability,
supported resource type and resource pattern), UE position information, UE mobility description,
etc.
Resource type (periodic, semi-persistent, aperiodic)
Number of requested SRS resource sets and SRS resources per set
Pathloss reference:
PCI, SSB Index
DL-PRS ID, DL-PRS Resource Set ID, DL-PRS Resource ID
Spatial relation info
PCI, SSB Index
DL-PRS ID, DL-PRS Resource Set ID, DL-PRS Resource ID
Non-zero-power (NZP) CSI-RS Resource ID
SRS Resource ID
Positioning SRS Resource ID
Geographical target area description according to a global coordinate system
Adjustable spatial info to a path-measurement conducted by the transmitter of the UL sensing
signal (e.g., angular information of a detected received path at the UE according to an indicated
condition on the path measurement is utilized for transmission of UL sensing signal). Adjustable
spatial information for a transmission beam or a reception beam may be indicated, e.g., via
indication of a quasi-co-location (QCL) type-D of a resource (e.g., a DL transmission resource) and
a path description information, e.g., describing via a condition/criteria (e.g., combination of angular
range, RSRPP range etc.) that to which path among the detected reception paths of the indicated
DL resource the Rx or Tx filter shall be adjusted.
Periodicity of the sensing signal, e.g., SRS for each SRS resource set
SSB Information
Carrier frequency of sensing signal (e.g., SRS) transmission bandwidth
Sensing target physical description (e.g., shape, size/dimension, RCS level information)

The TRP measurement request information that may be signaled from the SF or serving gNB to the gNBs is listed in Table 9.

TABLE 9
TRP Meas. request information that may be transferred from SF/Serv. gNB to gNBs.
Information

TRP ID, and NCGI of the TRP to receive sensing signals [for UL measurement and for TRP-TRP
measurements]
UE-sensing signal e.g., SRS, configuration
TRP-DL sensing signal (DL-PRS, CSI-RS) configuration
UL timing information together with timing uncertainty, for reception of sensing signal by
candidate TRPs
Report characteristics for the measurements [for UL measurement and for TRP-TRP
measurements]
Measurement Quantities [for UL measurement and for TRP-TRP measurements]
Measurement periodicity [for UL measurement and for TRP-TRP measurements]
Measurement beam information request [for UL measurement and for TRP-TRP measurements]
Search window information
Expected UL AoA/ZoA and uncertainty range of the LoS path or first arrival path, of one or
multiple NLOS paths or non-first arrival paths (reflective paths), of the sensing target, or
combination thereof
Expected path delay/time of arrival of a path [with respect to a transmitted RS, with respect to a
transmission/reception pair or node ID pair or RS resource ID pair]
Expected doppler shift/doppler shift range of a path associated with a target
Sensing target physical description (e.g., shape, size/dimension, RCS level information)
Target mobility description (e.g., target velocity, direction of movement, static/non-statics
indication flag)
Sensing target potential position (e.g., area of a potential target presence), or partial position
information (e.g., position information in one direction, altitude)
One or multiple candidate UEs (e.g., UE IDs) for sensing measurements
Information of the one or multiple UEs or candidate UEs participating in sensing measurement
including UE sensing capabilities (observable area, sensing transmission or reception capability,
supported resource type and resource pattern), position information, mobility description, etc.
Number of TRP Rx TEGs
Number of TRP RxTx TEGs
Response time
Measurement characteristics request indicator
Measurement time occasions for a measurement instance
A sensing/measurement path/path-group description
Conditional path measurement description
Relative path measurement description
Transmission configuration adjustments
Reception configuration adjustments

In some embodiments, the radio node (i.e., UE/gNB/TRP) transmits information regarding its capability for sensing measurements to the SensMF. The capability infomraton may include, but is not limited to, a type of the supported measurement (e.g., Rx (of a path)-Tx time or frequency difference), a supported time of measurements and/or reporting (e.g., the maximum supported duration of a sensing signal which can be utilized in a sensing measurement), a maximum time durations that the said node may store the obtained measurement data, a minimum time from reception and/or transmission of a sensing signal that an indicated measurement report can be transmitted by the radio node (e.g., the minimum time distance from the last symbol of a sensing signal at which the UE can transmit a measured Rx of a path associated with a sensing target to-Tx time difference in symbols), of the like. In such embodiments, the configuration of sensing measurements may be based, at least in part, on the capability information.

In some embodiments, as part of the information communicated from a sensing transmitter or a sensing receiver node to the SensMF, the radio node (i.e., UE/gNB/TRP) may transmit the spatial description of the one or more of transmission beam of a sensing signal, reception beam of a sensing signal at the gNB/RAN node, and/or at the radio node is communicated to the SensMF.

According to embodiments of a third solution, K number of UE devices are configured by a SensMF for one or more sensing signal transmission, reception, measurement, and reporting, such that the configuration of the node i comprises a configuration for the transmission of a sensing signal, the reception of one or multiple sensing signals, and obtaining one or multiple sensing measurement results, wherein the configured measurements comprise at least one circular directed graph of sensing measurements constructed by all or subset of the UEs 1-K.

More specifically, the configuration of the node i may indicate the transmission of sensing signal #i, e.g., wherein the sensing signals of different nodes may be multiplexed in time, in frequency, or in sequence/code domain, or via applying (time-dependent or frequency-dependent or joint time and frequency dependent with distinct rates for different sensing signal/nodes/transmissions) phase rotations over the REs or symbols carrying the sensing signal. In one example, all nodes are capable of full-duplex operation and all or multiple of the sensing signals share the same time and frequency resource and wherein a sensing node simultaneously transmits a configured sensing signal and receives (and further measures) the sensing signals transmitted by other sensing nodes. In one example, the configured sensing signal is a positioning reference signal for SL, a CSI-RS for SL, a sensing-dedicated RS for SL.

Further, the configuration of the node i may indicate the reception of up to K sensing signals, i.e., from sensing signal #1 to sensing signal #K, or a subset thereof. Where the node i is not capable of full-duplex operation, the configuration may indicate the reception of up to K−1 sensing signals, where the sensing signal #i is excluded from the sensing signals for reception and measurement. Relatedly, the configuration of the node i may indicate to performing sensing measurement on the received sensing signals, e.g., including an indication of a sensing measurement type, assisting information (e.g., target path description), etc.

Still further, the configuration of the node i may indicate to obtain one or multiple sensing measurement results associated with each of the received sensing signals or associated jointly with all or multiple of the received sensing signals, e.g., average of the measured ToA of multiple sensing signals or separately measured ToA of different sensing signals.

In accordance with the third solution, the SensMF may be a network entity (e.g., SF or serving gNB) or by a UE controlling/configuring the sensing operation. For example, a SF may configure the K number of UE devices via an LPP message or an enhanced LPP message for sensing message transfer or a sensing-dedicated logical interface over the N1 AMF-UE interface. As another example, the serving gNB of a sensing task may configure the K number of UE devices via the DL physical channels (e.g., message contained in PDSCH or PDCCH, or a DL broadcast message or a combination thereof). As yet another example, the controlling/configuring UE the sensing operation among multiple UEs (e.g., when the one or multiple of the UEs are out of network coverage) sensing signal transmission, reception, measurement, reporting a message contained in physical SL data/control channel or a SL broadcast message.

In some embodiments of the third solution, a part of the configuration parameters may be transferred to the K UEs from the network, as summarized above, while a remainder of the configuration parameters is transferred from a UE controlling/configuring the sensing operation. Such arrangement may be referred to as a “split configuration” of the K UEs.

In some embodiments of the third solution, for all of a subset of the K UEs, the positioning information (e.g., position, velocity) is known and reported by the corresponding UE or by the AMF or by the LMF (or a combination thereof) to the serving gNB of the sensing task and/or the SF.

In some embodiments of the third solution, the configuration (all or part of the configuration parameters thereof) of the sensing signal transmission/reception, sensing measurement and reporting or a combination thereof is indicated to the group of sensing nodes via a group common signaling.

In some embodiments of the third solution, all or subset of the configuration parameters of sensing signals are indicated via a group common signaling to the sensing nodes. Here, the dedicated signaling is used over the resource type over which the signals are multiplexed and the rest of the RS defining parameters is indicated via joint signaling.

In one example, the sequence generation and/or sequence-defining parameters of a reference signal used for sensing is defined as a shared sequence among all the sensing nodes; however, the physical resource mapping of the sequence at different sensing nodes e.g. mapping of the sequence to the time-frequency resources, the power boosting of the sensing signal of a node at a particular time-frequency resource, are indicated via dedicated signaling.

In another example, the time-frequency resources of multiple sensing signals are indicated via a group common signaling, whereas the sequence generation parameters and/or sequence phase rotation parameters are defined via dedicated signaling.

In some embodiments of the third solution, the measurement type of sensing nodes is indicated via a group common signaling (e.g., ToA and RSRPP of the path associated with the object of the received signal at all nodes shall be estimated).

In some embodiments, a dedicated configuration parameter (that may be different for different nodes belonging to the same group of sensing nodes), e.g., the time-frequency resources of sensing signals (to be transmitted by sensing node i) and/or time-frequency resources for reporting of the sensing measurement is computed at each node separately, based on combination of: 1) a joint parameter, function or a computation model indicated to all sensing nodes of the configured group (indicated via a joint group/common signaling); 2) a sensing node ID or a key belonging to a sensing node (indicated separately); and 3) a local sensing node information (e.g., based on a previous measurement, based on a node capability, etc.). In other words, the sensing operation may include local computation of dedicated sensing parameters by each node based on group common indications and the node local data.

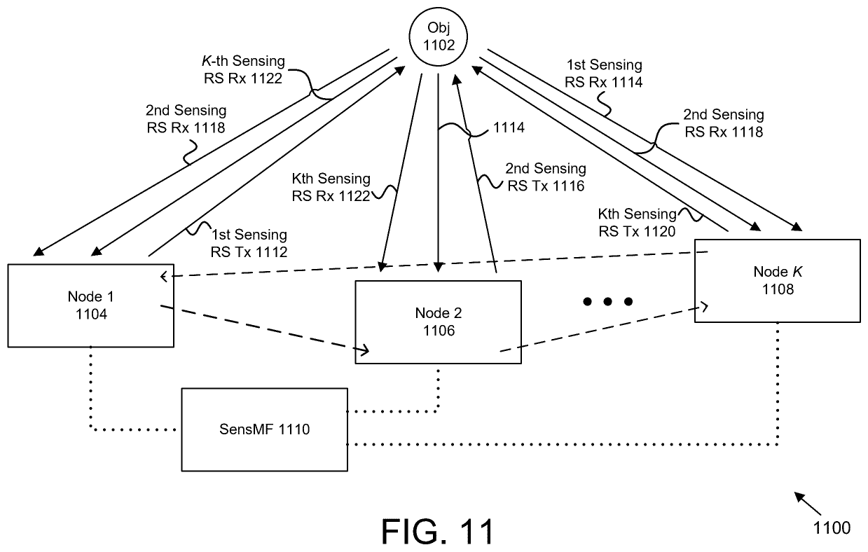

FIG. 11 illustrates a sensing group configuration for a group sensing operation 1100 including sensing transmissions by multiple nodes and sensing receptions of multiple nodes, in accordance with embodiments of the present disclosure. The group sensing operation 1100 is used to derive sensing information for an object 1102 and involves K measurement nodes, including a first node (denoted “Node 1”) 1104, a second node (denoted “Node 2”) 1106, and a K-th node (denoted “Node K”) 1108. The group sensing operation 1100 is coordinated/controlled by a SensMF 1110, which may be a network entity (e.g., SF or serving gNB) or by a controlling/configuring UE, as described above.

The group sensing operation 1100 involves the first node 1104 performing a first sensing RS transmission (Tx) 1112 and one or more measurement nodes (e.g., one or more of the second node 1106 through K-th node 1108) performing first sensing RS reception (Rx) 1114 and corresponding sensing measurements. Using another time/frequency resource, the second node 1106 performs a second sensing RS transmission (Tx) 1116 and/or more measurement nodes perform second sensing RS reception (Rx) 1118 and corresponding sensing measurements. In some embodiments, the sensing operation 1100 involves the remaining measurement nodes iteratively performing sensing RS transmission (while other measurement nodes perform corresponding sensing RS reception and measurement), until the K-th node 1108 performs a K-th sensing RS transmission (Tx) 1120 and/or more measurement nodes perform K-th sensing RS reception (Rx) 1122 and corresponding sensing measurements.

The sensing transmission and sensing receptions include at least one circular directed graph of measurements, e.g., including for one pair (i,j) of nodes the sensing signal transmission by node i and sensing measurement by node j of the transmitted signal by node i, and further transmission of a sensing signal by node j sensing measurement by node i of the transmitted signal by node j. In certain embodiments, the configuration may support multiple circular directed graphs of measurements. In the depicted configuration there may be a further circular directed graph of measurements, including a circular directed graph from the first node 1104 to the second node 1106, from the second node 1106 to the K-th node 1108, and from the K-th node 1108 to the first node 1104.

In some embodiments, the procedure described above is repeated multiple times for a configured sensing signal transmission, reception, measurement of a sensing node (and/or for the group of the configured sensing nodes) periodically, or via separately configured occasions.

In some embodiments, a subset of the transmission configuration of a sensing signal by the node j is determined by node j according to the received one or multiple sensing measurements based on the received signals from other nodes. In one example, the transmission time of the sensing signal by node j is determined according to a known (e.g., indicated by the SF) delay after reception of the path associated with the sensing target/object from node i or from all or a group of nodes (as an average measured value based on sensing signal transmission of group of nodes). Here, the transmission time for the sensing signal by node j (which transmission is subsequent to the reception at node j of the sensing signal from node i) is relative to the received ToA (e.g., average ToA) from the target object.

In some embodiments, the transmission beam of the sensing signal by node j is determined as a beam with an angular information corresponding to the reception of the path associated with the sensing target/object based on sensing signal of node i or from all or a group of nodes (as an average measured value based on sensing signal transmission of group of nodes). Here, the transmission beam for the sensing signal by node j (which transmission is subsequent to the reception at node j of the sensing signal from node i) is relative to the received angle (e.g., AoA and/or ZoA) of the propagation path associated with the target object.

In some embodiments, the transmission frequency shift of the sensing signal by node j is determined based on an estimated doppler frequency shift corresponding to the reception of the path associated with the sensing target/object based on sensing signal of node i or from all or a group of nodes (as an average measured value based on sensing signal transmission of group of nodes). In some embodiments, the transmission frequency shift is implemented via applying phase rotations to the sensing signal REs at different time symbols, proportional to the time instance (clock stamp or symbol number within an NR frame). Here, the transmission frequency shift for the sensing signal by node j (which transmission is subsequent to the reception at node j of the sensing signal from node i) is relative to an estimated doppler shift of the propagation path associated with the target object.

In one example, SensMF configures a group of UEs for sensing (including assigning a UE ID to each UE part of the group sensing operation), wherein an initial slot number within a frame is indicated as a common IE to all UEs via a group common signaling, and wherein the transmission of each node is performed at the initial slot+slot*UE ID, in the first round towards an indicated (via a group common indication) area of interest (with a first beam which is a wide beam). The configured UEs upon reception of the transmitted sensing signal by other nodes measure at least one or more of the ToA, AoA, ZoA, doppler shift, RSRPP of the path(s) associated with the sensing target based on the reception of the transmitted signal. The sensing nodes then transmit the sensing signal in the next round utilizing a Tx beam according to the estimated received angle of the path associated with the sensing target and/or at a time instance determined according to the estimated said ToA. In one example, the estimated measurements are reported for the path associated with the object to the SensMF.

In another example, the transmission is done at node j according to a known (e.g., indicated) time difference from the ToA of the received sensing signal from node i, wherein the node i further receives the transmitted signal from node j and reports the measured RTT, RTD, etc. to the SensMF where the measured ToA at node j is not reported to the SensMF directly by the node j.

As an extension to the third solution, the SensMF may configure a group of at least 3 nodes (Nodes i, j, k) and including at least one UE for sensing signal transmission, sensing signal reception, sensing measurement, reporting (or a combination thereof), wherein the sensing target information (presence, target position, etc. of a sensing target) and/or the position information of a UE belonging to the group is obtained by the SensMF based on, at least in part, combination of the sensing measurements of: 1) measurement of UE Node j based on transmission of UE Node i, 2) measurement of UE Node i based on transmission of gNB/TRP Node k, and 3) transmission of UE Node j and reception of gNB/TRP Node k.

In some embodiments, Tx-Rx time difference is indicated based on definitions given in Table 10 and/or Table 11. In some embodiments, the UE (e.g., Node i) is configured to transmit the UL and/or SL sensing signal according to a configured time difference (e.g., an indicated UE Rx (path) Tx (UL) or UE Rx (path) Tx (SL) or a time-delay (TD) from the start of a subframe, by the SensMF).

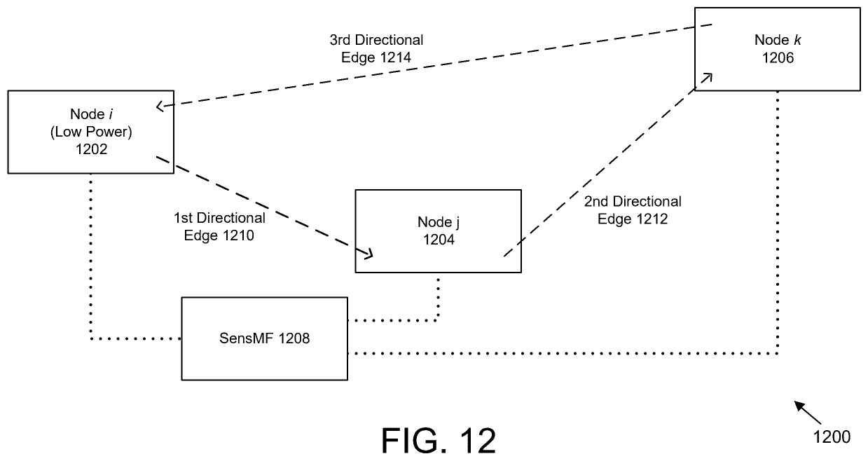

FIG. 12 depicts a sensing group configuration 1200 including sensing transmissions by multiple nodes and sensing receptions of multiple nodes, including at least one circular directed graph of measurements. The multiple nodes include a Node i 1202, a Node j 1204, and a Node k 1206. In certain embodiments, the Node i 1202 operates in a low power mode. The group sensing operation is coordinated/controlled by a SensMF 1208, which may be a network entity (e.g., SF or serving gNB) or by a controlling/configuring UE, as described above. The Node i 1202, a Node j 1204, and a Node k 1206 form the vertices of the circular directed graph. The circular directed graph also comprises a first directional edge 1210, a second directional edge 1212, and a third directional edge 1214.

In the illustrated embodiment, the sensing group configuration 1200 comprises three nodes (i.e., a circular directed graph consisting three vertices of Nodes i, j, k), wherein the Node i 1202 (a reduced capability or low-power UE node, or a UE with a low energy storage, which is restricted in the affordable transmission power) is capable of receiving and performing measurement on a sensing signal transmitted by the Node k 1206 (e.g., a gNB or a UE) and transmission of a sensing signal measurable by Node j 1204 (e.g., a UE in a close vicinity to the Node i). The sensing signal transmission by Node i 1202 is measurable (observable) by Node j 1204. However, in some examples, the sensing signal transmission by Node i 1202 is not measurable (observable) by Node k 1206 due to the low power transmission capability of the Node i 1206 and a relatively long propagation distance between Node k 1206 and Node i 1202 (i.e., as compared to a propagation distance between the Node j 1204 and Node i 1202.

In one example, the sensing configuration of the above sensing group (of the circular directed graph comprises three vertices of Nodes i, j, k) comprising transmission of sensing signal by the node originating a blue arrow of FIG. 4.5.1 and measurement of the said sensing signal by the node ending the said blue arrow. In some examples, the SensMF obtains round trip propagation time and/or round-trip doppler shift of the said directed graph consisting of the depicted blue edges, at least in part, based on the Rx-Tx (or Tx-Rx) time difference measurements of each of the said vertices, Rx-Tx (or Tx-Rx) frequency difference measurements of each of the said vertices or a combination thereof.

As used herein, the frequency difference of two signals may be a frequency shift value that, when applied on the first signal, generates a shifted signal that is closest (among different frequency shift values) to the second signal (based on e.g., energy of the difference of the said two signals), or difference of the two frequencies associated with the two said signals, e.g., the center frequency of a signal, the weighted average (by available energy of the corresponding frequency within the said signal) of a signal frequency, or the starting/ending frequency of a first/last resource element or physical resource block within the signal.

Moreover, the frequency difference of a first signal and a frequency reference includes difference of a frequency associated with the first signal (e.g., as described above) and the said frequency reference. In some embodiments, the frequency doppler shift of a signal may include the frequency difference of the received said signal and the expected frequency of the received signal when no moving object or Tx/Rx entity is present in the propagation environment.

In one example, the measurement of the said sensing group is configured to include identification and measurement on the LoS path between the sensing transmitter node and the sensing receiver node. In one such example, the position of the said low-power UE is to be obtained by the said SensMF, at least in part, based on the obtained round-trip propagation time of the depicted circular directed graph.

TABLE 10
UE Rx (path)-Tx (SL) time difference

| | |
|---|---|
| Definition | The UE Rx-Tx time difference is defined as: |
| | T_{UE-RX} (Rx Path)-T_{UE-TX} (SL) |
| | Where: |
| | T_{UE-RX} (Rx Path) is the UE received timing of the DL subframe/slot/symbol #i from a |
| | Transmission Point (TP), defined by the detected path (Rx Path) and wherein the Rx |
| | Path may be defined in association with a sensing target or a as an arrived path number |
| | ordered according to the path strength (RSRPP), path arrival time (e.g., first/second |
| | arrival path), doppler shift (path presenting the largest doppler frequency shift). |
| | T_{UE-TX} (SL) is the UE transmit timing of SL subframe/slot/symbol (according to a frame |
| | structure used for SL transmission of a UE) #j that is closest in time to the DL |
| | subframe/slot/symbol #i received from the Rx path. |
| | Multiple sensing signals (e.g., DL PRS or CSI-RS for tracking resources) can be used to |
| | determine the start of the subframe/slot/symbol of the Rx path. |

TABLE 11
UE Rx (path, DL/SL)-Tx (SL/UL) time difference

| | |
|---|---|
| Definition | The UE Rx-Tx time difference is defined as: |
| | T_{UE-RX} (Rx Path)-T_{UE-TX} (SL) |
| | Where: |
| | T_{UE-RX} (Rx Path) is the UE received timing of the DL/SL subframe/slot/symbol #i, |
| | defined by the detected path (Rx Path) and wherein the Rx Path may be defined in |
| | association with a sensing target or a as an arrived path number ordered according to the |
| | path strength (RSRPP) path arrival time (e.g., first/second arrival path), doppler shift |
| | (path presenting the largest doppler frequency shift). |
| | T_{UE-TX} (SL/UL) is the UE transmit timing of SL/UL subframe/slot/symbol (e.g., |
| | according to a frame structure used for SL or UL transmission of a UE) #j that is closest |
| | in time to the DL/SL subframe/slot/symbol #i received from the Rx path or is |
| | indicated/configured according to the UE SL/UL frame (e.g., start of an indicated |
| | subframe) |
| | Multiple sensing signals (e.g., DL PRS or CSI-RS for tracking resources) can be used to |
| | determine the start of the subframe/slot/symbol of the Rx path. |

In some embodiments, a UE Rx-Tx time difference value is indicated to a UE (by the SF or the serving gNB of the assigned sensing task) according to which the UE adjusts transmission of the configured RS signal (e.g., UL SRS, SL RS, sensing RS etc.) according to the received signal timing of an indicated Rx Path (applicable for both UE Rx-Tx time difference for SL reception and DL reception) and according to the indicated Ue Rx-Tx time difference. Note here that the SensMF uses the IE UE Rx-Tx time difference to generate a customized delay (not for measurement) in order to implement over-the-air (OTA) delay aggregation. In some embodiments, an additional waiting time is indicated to the UE for UL or SL sensing signal transmission (by the SF or the serving gNB of the UE or the assigned sensing task) such that the transmission of the UL or SL sensing signal is performed after the detected timing of the indicated Rx path at the UE in addition to the UE Rx-Tx time difference and in addition to the further indicated delay (1 subframe, Nx number of NR symbols within a frame with SCS x).

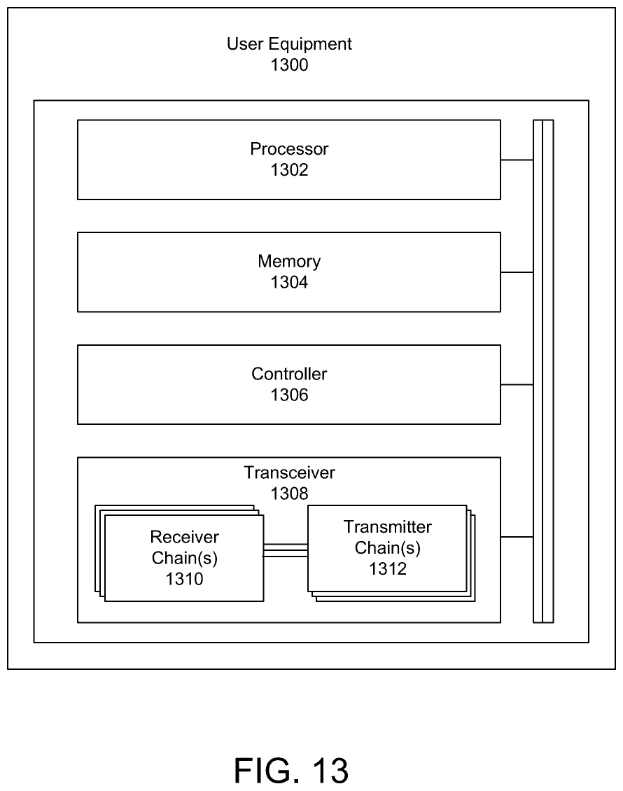

FIG. 13 illustrates an example of a UE 1300 in accordance with aspects of the present disclosure. The UE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a central processing unit (CPU), an ASIC, a field programmable gate array (FPGA), or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the UE 1300 to perform various functions of the present disclosure.

The memory 1304 may include volatile or non-volatile memory. The memory 1304 may store computer-readable, computer-executable code including instructions that, when executed by the processor 1302, cause the UE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the UE 1300 to perform one or more of the UE functions described herein (e.g., executing, by the processor 1302, instructions stored in the memory 1304). Accordingly, the processor 1302 may support wireless communication at the UE 1300 in accordance with examples as disclosed herein. For example, the UE 1300 may be configured to support a means for receiving a sensing configuration for performing a sensing signal transmission and at least one sensing measurement and means for performing at least one sensing measurement based on a first sensing signal.

In various embodiments, the UE 1300 may be configured to support a means for transmitting a second sensing signal in accordance with the sensing configuration, where the sensing configuration indicates a time difference between a reception of the first sensing signal and a time of transmission of the second sensing signal, or a time difference between a reception of the first sensing signal and a time reference, or a frequency difference between the reception of the first sensing signal and a transmission frequency of the second sensing signal, or a frequency difference between the reception of the first sensing signal and a reference frequency, or a combination thereof.

In certain embodiments, the UE 1300 may be configured to receive an indication of the time reference associated with the second sensing signal, or the reference frequency associated with the second sensing signal, or both. In certain embodiments, the time reference associated indicates the start of the closest symbol, or slot, or subframe, to the reception of the first sensing signal or the transmission of the second sensing signal. In certain embodiments, the reference frequency associated with the second sensing signal indicates the starting frequency of a physical resource block within the transmission frame associated with the second sensing signal. In other embodiments, the reference frequency indicates an expected reception frequency of the first sensing signal assuming a static environment and static radio nodes.

In some embodiments, the sensing configuration further indicates one or more of: A) a time of the reception of the first sensing signal; B) a set of reception time-frequency resources for receiving the first sensing signal; C) a set of transmission time-frequency resources for transmitting the second sensing signal; or D) a combination thereof.

In some embodiments, the sensing configuration further indicates a set of measurement parameters associated with a propagation path, where the set of measurement parameters comprises one or more of: a RSRPP, an AoA, a ZoA, a ToA, a ToF, a doppler shift, a path-specific receive-to-transmit (Rx-to-Tx) time difference (also referred to as “Rx(path)-to-TX time difference”), a path-specific transmit-to-receive (Tx-to-Rx) time difference (also referred to as “Tx-to-Rx(path) time difference”), a path-specific Rx-to-Tx frequency difference (also referred to as “Rx(path)-to-TX frequency difference”), a path specific Tx-to-Rx frequency difference (also referred to as “Tx-to-Rx(path) frequency difference”), or a combination thereof.

In some embodiments, the sensing configuration comprises an identification of one or more reflective propagation paths associated with a sensing target object, such that the identification of the one or more reflective propagation paths is based at least in part on a description of the one or more reflective propagation paths. In some embodiments, the sensing configuration comprises an identification of one or more propagation paths with LoS condition towards a sensing Rx radio node.

In various embodiments, the UE 1300 may be configured to support a means for transmitting a measurement report based at least in part on the at least one sensing measurement. In some embodiments, the UE 1300 is further configured to receiving a reporting configuration for the measurement report, where the measurement report indicates a measured time delay between an arrival time (i.e., time of reception) of the first sensing signal and the transmission of the second sensing signal or a frequency shift between a detected frequency of the first sensing signal and the transmission frequency of the second sensing signal, or both.

In certain embodiments, the reporting configuration indicates a timing or condition for a transmission of the measurement report. More specifically, the reporting configuration may include at least one type of measurement quantities to be reported, and one or more conditions over which the measured quantities are obtained, e.g., when measurement of the frequency of the first sensing signal is performed based on a portion of the first sensing signal the measured time-window of the received first sensing signal is also reported (e.g., K number of time-periods of a first sensing signal with periodic resource assignment), the estimated accuracy of the obtained measurement quantities, or a combination thereof. In some examples, upon reception of the reporting configuration comprising a time pattern for possible reporting occasions and at least one reporting condition (e.g., the measured RSRPP of the detected path of the first sensing signal is above an indicated threshold to the radio node) the radio node determines the closest reporting occasion to the time instance that the satisfaction of the said one or more conditions are determined and utilized the said reporting occasion for transmission of the report.

In some embodiments, a set of transmission parameters for the transmission of the second sensing signal is based at least in part on the at least one sensing measurement. For example, the set of transmission parameters may indicate a transmission beam, a time difference to be applied/enforced, a frequency difference to be applied/enforced, etc.

In certain embodiments, to transmit the second sensing signal, the UE 1300 is further configured to adjust a transmission beam based at least in part on an estimated direction of arrival of the first sensing signal, such that the estimated direction of arrival is measured on a propagation path associated with a sensing target.

In certain embodiments, the time of transmission of the second sensing signal is based on the indicated time difference and an arrival time of the first sensing signal via a propagation path associated with a sensing target.

In certain embodiments, the transmission frequency of the second sensing signal is based on the indicated frequency difference (e.g., the indicated subcarrier resource of the second sensing signal and the difference thereof with the assigned subcarrier resource of the first sensing signal, e.g., zero distance in case of the same subcarrier resource assignment are used for transmission of the second sensing signal and reception of the first sensing signal) and a detected frequency or detected doppler shift, or both, of the first sensing signal via a propagation path associated with a sensing target (e.g., detected frequency of the first sensing signal arriving from the path associated with sensing signal is shifted according to the indicated said distance to generate the transmission of the second sensing signal, or the detected doppler shift of the first sensing signal is added to the transmission frequency scheduled/assigned for the second sensing signal, e.g., by applying a time/symbol-dependent phase rotation over the duration of the second sensing signal at the subcarrier/time resources indicated for the transmission of the second sensing signal).

In some embodiments, the UE 1300 is further configured to identify a respective propagation path based at least in part on: A) an indicated propagation time/delay characteristic of the respective propagation path; B) an indicated propagation path directional information of the respective propagation path; C) an indicated movement/mobility pattern associated with the respective propagation path; D) an indicated energy/power associated with the respective propagation path; E) an indicated pattern describing a group of paths where the path is a member of the group of paths; F) an indicated relative description of an identified path or a known path; or G) a combination thereof.

In some embodiments, the UE 1300 receives the first sensing signal on a propagation path in a DL direction or a first SL direction, and transmits the second sensing signal on the propagation path in an UL direction or a second SL direction.

In some embodiments, the sensing configuration indicates a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. In such embodiments, a starting vertex a respective directional edge corresponds to a transmitting radio node associated with a transmission of a respective sensing signal, and where a terminating vertex of the respective directional edge corresponds to a receiving radio node associated with a reception and measurement of the respective sensing signal.

In various embodiments, the UE 1300 may support wireless communication of a SensMF, in accordance with examples as disclosed herein. For example, the UE 1300 may be configured to support a means for determining a set of radio nodes for performing sensing signal transmission and sensing measurements. The set of radio nodes forms a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. Further, a starting vertex a respective directional edge corresponds to a transmitting radio node associated with a transmission of a respective sensing signal, and a terminating vertex of the respective directional edge corresponds to a receiving radio node associated with a reception and measurement of the respective sensing signal.

In some embodiments, the directional circular graph comprising N number of vertices (e.g., radio nodes described/numbered with indices of 1 . . . N) and N number of edges (e.g., sensing measurements described with indices of 1 . . . N) and where the directional edge n A): originates from the vertex node n and terminates at the node n+1, for n∈{1 . . . N−1}; and B) originates from the vertex node N and terminates at the node 1, for n=N. In certain embodiments, the numbering of the edges may correspond to the timing of the sensing signal, e.g., the first transmitted sensing signal is assigned to an edge of a lower index number, or may be assigned with any interpretation of the ordering of the nodes and/or edges, e.g., at random.

In certain embodiments, the set of radio nodes comprises between two and four radio nodes that form the circular directional graph. Note that the word “circular” in “circular directional graph” does not indicate that the radio nodes are arranged in any particular shape or geometric arrangement. Rather, the term “circular” denotes that, for a set of N radio nodes, the first transmitting radio node is also the receiving radio node for the sensing signal transmission performed by the Nth radio node.

In some embodiments, the UE 1300 may be configured to support a means for transmitting, to the set of radio nodes, a sensing configuration for performing the sensing signal transmission and the sensing measurements. In some embodiments, the sensing configuration for performing the sensing signal transmission and the sensing measurements comprises an indication of one or more of: A) a time when a respective radio node of the set of radio nodes is to transmit or to receive a sensing signal, or both; or B) a set of time-frequency resources for transmitting the sensing signal, or for receiving the sensing signal, or both; or C) a combination thereof.

In certain embodiments, a set of transmission parameters for a transmission of the sensing signal (e.g., associated with edge n+1) is based at least in part on a sensing measurement (e.g., obtained/estimated measurement values/parameters) associated with a prior sensing signal (e.g., the sensing signal associated with edge n) at the respective radio node (e.g., node n∈{1 . . . N−1}).

In certain embodiments, the transmission of the sensing signal corresponds to a transmission beam adjustment based at least in part on an estimated direction of arrival of the prior sensing signal, such that the estimated direction of arrival is measured on a propagation path associated with a sensing target.

In certain embodiments, the transmission of the sensing signal corresponds to a transmission time instance with an indicated time distance (e.g., an indicated Rx-to-Tx time difference as part of the configuration parameters) of a detected arrival time of the prior sensing signal via a propagation path associated with a sensing target. Note that the SensMF may indicate the time distance to the measurement radio node, and the measurement radio node utilizes the indicated time distance to generate its transmission (i.e., with the indicated time distance) to the reception of the prior signal from the identified path.

In certain embodiments, the transmission of the sensing signal corresponds to a transmission frequency or frequency/doppler shift, or both (e.g., applied to the sensing signal of the second measurement edge), with an indicated frequency distance (e.g., an indicated Rx-to-Tx frequency difference as part of configuration information) based at least in part on a detected (e.g., measured/estimated) frequency or doppler shift, or both, of the prior sensing signal via a propagation path associated with a sensing target. Note that the SensMF may indicate the frequency distance and the measurement radio node, and the measurement radio node utilizes the indicated frequency distance to generate its transmission (i.e., with the indicated frequency distance) to the reception of the prior signal from the identified path.

In certain embodiments, the sensing configuration further indicates a set of measurement parameters associated with a propagation path, where the set of measurement parameters comprises one or more of: a RSRPP, an AoA, a ZoA, a ToA, a ToF, a doppler shift, or a combination thereof.

In certain embodiments, the sensing configuration comprises an identification of one or more reflective propagation paths associated with a sensing target object, such that the identification of the one or more reflective propagation paths is based at least in part on a description of the one or more reflective propagation paths. For example, the description may be a permissible/potential range of path AoA, ZoA, arrival time, doppler shift, etc., according to the location services (LCS) of a measuring radio node (e.g., sensing Rx node) or a known/global coordinate system.

In certain embodiments, the sensing configuration comprises an identification of one or more propagation paths with LoS condition towards a sensing Rx radio node. For example, the description may be a permissible/potential range of path AoA, ZoA, arrival time, doppler shift, etc., according to the LCS of the measuring radio node (e.g., sensing Rx node) or a known/global coordinate system. In such embodiments, the one or more propagation paths the LoS condition are propagation paths associated to a sensing area of interest with LoS condition passing through a sensing area of interest when object may not be present and/or paths with LoS condition between two sensing Rx and sensing Tx node, for which the positioning/sensing information of the said sensing Rx and/or sensing Tx nodes are of interest.

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in a DL direction or a first SL direction, and a transmission of a second sensing signal on the propagation path in an UL direction or a second SL direction (i.e., the difference of the detected arrival time of a first sensing signal to the transmission time of the second sensing signal). In such embodiments, the reception, transmission, measurement of the UL, DL, and SL directions imply reception timing, or transmission timing (or both), according to the UL/DL/SL frame timing at the radio node. In such embodiments, the respective radio node (i.e., UE radio node) is a vertex of ve as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in an UL direction or a first inter-RAN node direction, and a transmission of a second sensing signal on the propagation path in a DL direction or a second inter-RAN node direction (i.e., the difference of the detected arrival time of a first sensing signal to the transmission time of the second sensing signal). For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ve as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception frequency of a first sensing signal on a propagation path or a differential between the reception frequency of the first sensing signal on the propagation path in a DL direction or a first SL direction, and a transmission frequency of a second sensing signal on the propagation path in an UL direction or a second SL direction.

In some embodiments, the sensing configuration for a respective radio node comprises a reception frequency of a first sensing signal on a propagation path (e.g., a path associated to a sensing target, detected/identified by the respective radio node based on the configuration information (received from the SensMF) comprising description of the path) or a differential between the reception frequency of the first sensing signal on the propagation path in an UL direction or a first inter-RAN node direction, and a transmission frequency of a second sensing signal on the propagation path in a DL direction or a second inter-RAN node direction. For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ν_{c} as a terminating vertex of a first edge starting with a first UE or gNB/TRP node and starting vertex of a second edge ending with a second UE or gNB/TRP (e.g., the same as or different than the first UE or gNB/TRP node).

In some embodiments, the UE 1300 may be configured to support a means for receiving at least one measurement report corresponding to the sensing signal transmission and sensing measurements. In some embodiments, the UE 1300 may be configured to support a means for determining sensing information based at least in part on combined measurement values associated with the plurality of directional edges.

In certain embodiments, the combined measurement values include a sum of a respective propagation delay of a set of propagation paths along the plurality of directional edges (e.g., sum of the propagation delay of paths associated with sensing target reflection, or sum of the propagation delay of the paths with first-arrival or LoS condition between the vertices of each edge). In such embodiments, the sum may be determined by summation of the measured and reported ToF, or by the total time of the first sensing signal transmission at the first edge to the last signal reception at the last edge from which the Rx (from the propagation path associated to the sensing target)-to-Tx time difference of all nodes (other than the first node, corresponding to the transmitter of the first sensing signal) is subtracted.

In certain embodiments, the combined measurement values include a sum of a respective doppler frequency shift of a set of propagation paths along the plurality of directional edges (e.g., sum of the doppler frequency shifts of paths associated with sensing target reflection, or sum of the doppler frequency shifts of the paths with first-arrival or LoS condition between the vertices of each edge). In such embodiments, the said sum may be determined by summation of the measured and reported doppler shift, or by the total frequency difference of the first sensing signal transmission at the first edge to the last signal reception at the last edge from which the Rx (from the propagation path associated to the sensing target)-to-Tx frequency shift/difference of all intermediate nodes is subtracted.

The controller 1306 may manage input and output signals for the UE 1300. The controller 1306 may also manage peripherals not integrated into the UE 1300. In some implementations, the controller 1306 may utilize an operating system (OS) such as iOS®, ANDROID®, WINDOWS®, or other operating systems. In some implementations, the controller 1306 may be implemented as part of the processor 1302.

In some implementations, the UE 1300 may include at least one transceiver 1308. In some other implementations, the UE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receiving the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the received signal and obtain the transmitted data by reversing the modulation technique applied during transmission of the signal. The receiver chain 1310 may include at least one decoder for decoding/processing the demodulated signal to receive the transmitted data.

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium.

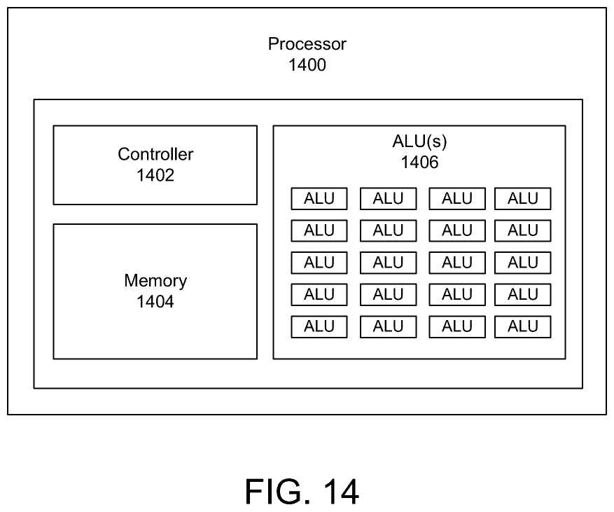

FIG. 14 illustrates an example of a processor 1400 in accordance with aspects of the present disclosure. The processor 1400 may be an example of a processor configured to perform various operations in accordance with examples as described herein. The processor 1400 may include a controller 1402 configured to perform various operations in accordance with examples as described herein. The processor 1400 may optionally include at least one memory 1404, which may be, for example, an L1/L2/L3 cache. Additionally, or alternatively, the processor 1400 may optionally include one or more arithmetic-logic units (ALUs) 1406. One or more of these components may be in electronic communication or otherwise coupled (e.g., operatively, communicatively, functionally, electronically, electrically) via one or more interfaces (e.g., buses).

The processor 1400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1402 may be configured to manage and coordinate various operations (e.g., signaling, receiving, obtaining, retrieving, transmitting, outputting, forwarding, storing, determining, identifying, accessing, writing, reading) of the processor 1400 to cause the processor 1400 to support various operations in accordance with examples as described herein. For example, the controller 1402 may operate as a control unit of the processor 1400, generating control signals that manage the operation of various components of the processor 1400. These control signals include enabling or disabling functional units, selecting data paths, initiating memory access, and coordinating timing of operations.

The controller 1402 may be configured to fetch (e.g., obtain, retrieve, receive) instructions from the memory 1404 and determine subsequent instruction(s) to be executed to cause the processor 1400 to support various operations in accordance with examples as described herein. The controller 1402 may be configured to track memory address of instructions associated with the memory 1404. The controller 1402 may be configured to decode instructions to determine the operation to be performed and the operands involved. For example, the controller 1402 may be configured to interpret the instruction and determine control signals to be output to other components of the processor 1400 to cause the processor 1400 to support various operations in accordance with examples as described herein. Additionally, or alternatively, the controller 1402 may be configured to manage flow of data within the processor 1400. The controller 1402 may be configured to control transfer of data between registers, arithmetic logic units (ALUs), and other functional units of the processor 1400.

The memory 1404 may include one or more caches (e.g., memory local to or included in the processor 1400 or other memory, such RAM, ROM, DRAM, SDRAM, SRAM, MRAM, flash memory, etc. In some implementations, the memory 1404 may reside within or on a processor chipset (e.g., local to the processor 1400). In some other implementations, the memory 1404 may reside external to the processor chipset (e.g., remote to the processor 1400).

The memory 1404 may store computer-readable, computer-executable code including instructions that, when executed by the processor 1400, cause the processor 1400 to perform various functions described herein. The code may be stored in a non-transitory computer-readable medium such as system memory or another type of memory. The controller 1402 and/or the processor 1400 may be configured to execute computer-readable instructions stored in the memory 1404 to cause the processor 1400 to perform various functions. For example, the processor 1400 and/or the controller 1402 may be coupled with or to the memory 1404, the processor 1400, the controller 1402, and the memory 1404 may be configured to perform various functions described herein. In some examples, the processor 1400 may include multiple processors and the memory 1404 may include multiple memories. One or more of the multiple processors may be coupled with one or more of the multiple memories, which may, individually or collectively, be configured to perform various functions herein.

The one or more ALUs 1406 may be configured to support various operations in accordance with examples as described herein. In some implementations, the one or more ALUs 1406 may reside within or on a processor chipset (e.g., the processor 1400). In some other implementations, the one or more ALUs 1406 may reside external to the processor chipset (e.g., the processor 1400). One or more ALUs 1406 may perform one or more computations such as addition, subtraction, multiplication, and division on data. For example, one or more ALUs 1406 may receive input operands and an operation code, which determines an operation to be executed. One or more ALUs 1406 be configured with a variety of logical and arithmetic circuits, including adders, subtractors, shifters, and logic gates, to process and manipulate the data according to the operation. Additionally, or alternatively, the one or more ALUs 1406 may support logical operations such as AND, OR, exclusive-OR (XOR), not-OR (NOR), and not-AND (NAND), enabling the one or more ALUs 1406 to handle conditional operations, comparisons, and bitwise operations.

In various embodiments, the processor 1400 may support wireless communication of a sensing radio node, such as a UE or gNB, in accordance with examples as disclosed herein. For example, the processor 1400 may be configured to support a means for receiving a sensing configuration for performing a sensing signal transmission and at least one sensing measurement and means for performing at least one sensing measurement based on a first sensing signal.

In various embodiments, the processor 1400 may be configured to support a means for transmitting a second sensing signal in accordance with the sensing configuration, where the sensing configuration indicates a time difference between a reception of the first sensing signal and a time of transmission of the second sensing signal, or a time difference between a reception of the first sensing signal and a time reference, or a frequency difference between the reception of the first sensing signal and a transmission frequency of the second sensing signal, or a frequency difference between the reception of the first sensing signal and a reference frequency, or a combination thereof.

In certain embodiments, the processor 1400 may be configured to receive an indication of the time reference associated with the second sensing signal, or the reference frequency associated with the second sensing signal, or both. In certain embodiments, the time reference associated indicates the start of the closest symbol, or slot, or subframe, to the reception of the first sensing signal or the transmission of the second sensing signal. In certain embodiments, the reference frequency associated with the second sensing signal indicates the starting frequency of a physical resource block within the transmission frame associated with the second sensing signal. In other embodiments, the reference frequency indicates an expected reception frequency of the first sensing signal assuming a static environment and static radio nodes.

In some embodiments, the sensing configuration further indicates one or more of: A) a time of the reception of the first sensing signal; B) a set of reception time-frequency resources for receiving the first sensing signal; C) a set of transmission time-frequency resources for transmitting the second sensing signal; or D) a combination thereof.

In some embodiments, the sensing configuration further indicates a set of measurement parameters associated with a propagation path, where the set of measurement parameters comprises one or more of: a RSRPP, an AoA, a ZoA, a ToA, a ToF, a doppler shift, a path-specific Rx-to-Tx time difference (i.e., Rx(path)-to-TX time difference), a path-specific Tx-to-Rx time difference (i.e., Tx-to-Rx(path) time difference), a path-specific Rx-to-Tx frequency difference (i.e., Rx(path)-to-TX frequency difference), a path specific Tx-to-Rx frequency difference (i.e., Tx-to-Rx(path) frequency difference), or a combination thereof.

In some embodiments, the sensing configuration comprises an identification of one or more reflective propagation paths associated with a sensing target object, such that the identification of the one or more reflective propagation paths is based at least in part on a description of the one or more reflective propagation paths. In some embodiments, the sensing configuration comprises an identification of one or more propagation paths with LoS condition towards a sensing Rx radio node.

In various embodiments, the processor 1400 may be configured to support a means for transmitting a measurement report based at least in part on the at least one sensing measurement. In some embodiments, the processor 1400 is further configured to receiving a reporting configuration for the measurement report, where the measurement report indicates a measured time delay between an arrival time (i.e., time of reception) of the first sensing signal and the transmission of the second sensing signal or a frequency shift between a detected frequency of the first sensing signal and the transmission frequency of the second sensing signal, or both.

In certain embodiments, the reporting configuration indicates a timing or condition for a transmission of the measurement report. More specifically, the reporting configuration may include at least one type of measurement quantities to be reported, and one or more conditions over which the measured quantities are obtained, e.g., when measurement of the frequency of the first sensing signal is performed based on a portion of the first sensing signal the measured time-window of the received first sensing signal is also reported (e.g., K number of time-periods of a first sensing signal with periodic resource assignment), the estimated accuracy of the obtained measurement quantities, or a combination thereof. In some examples, upon reception of the reporting configuration comprising a time pattern for possible reporting occasions and at least one reporting condition (e.g., the measured RSRPP of the detected path of the first sensing signal is above an indicated threshold to the radio node) the radio node determines the closest reporting occasion to the time instance that the satisfaction of the said one or more conditions are determined and utilized the said reporting occasion for transmission of the report.

In some embodiments, a set of transmission parameters for the transmission of the second sensing signal is based at least in part on the at least one sensing measurement. For example, the set of transmission parameters may indicate a transmission beam, a time difference to be applied/enforced, a frequency difference to be applied/enforced, etc.

In certain embodiments, to transmit the second sensing signal, the processor 1400 is further configured to adjust a transmission beam based at least in part on an estimated direction of arrival of the first sensing signal, such that the estimated direction of arrival is measured on a propagation path associated with a sensing target.

In certain embodiments, the time of transmission of the second sensing signal is based on the indicated time difference and an arrival time of the first sensing signal via a propagation path associated with a sensing target.

In certain embodiments, the transmission frequency of the second sensing signal is based on the indicated frequency difference (e.g., the indicated subcarrier resource of the second sensing signal and the difference thereof with the assigned subcarrier resource of the first sensing signal, e.g., zero distance in case of the same subcarrier resource assignment are used for transmission of the second sensing signal and reception of the first sensing signal) and a detected frequency or detected doppler shift, or both, of the first sensing signal via a propagation path associated with a sensing target (e.g., detected frequency of the first sensing signal arriving from the path associated with sensing signal is shifted according to the indicated said distance to generate the transmission of the second sensing signal, or the detected doppler shift of the first sensing signal is added to the transmission frequency scheduled/assigned for the second sensing signal, e.g., by applying a time/symbol-dependent phase rotation over the duration of the second sensing signal at the subcarrier/time resources indicated for the transmission of the second sensing signal).

In some embodiments, the processor 1400 is further configured to identify a respective propagation path based at least in part on: A) an indicated propagation time/delay characteristic of the respective propagation path; B) an indicated propagation path directional information of the respective propagation path; C) an indicated movement/mobility pattern associated with the respective propagation path; D) an indicated energy/power associated with the respective propagation path; E) an indicated pattern describing a group of paths, where the path is a member of the group of paths; F) an indicated relative description of an identified path or a known path; or G) a combination thereof.

In some embodiments, the radio node comprises a UE, such that the first sensing signal is received on a propagation path in a DL direction or a first SL direction, where the second sensing signal is transmitted on the propagation path in an UL direction or a second SL direction.

In some embodiments, the radio node comprises a RAN node, such that the first sensing signal is received on a propagation path in an UL direction or a first inter-RAN node direction, where the second sensing signal is transmitted on the propagation path in a DL direction or a second inter-RAN node direction.

In some embodiments, the sensing configuration indicates a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. In such embodiments, a starting vertex a respective directional edge corresponds to a transmitting radio node associated with a transmission of a respective sensing signal, and where a terminating vertex of the respective directional edge corresponds to a receiving radio node associated with a reception and measurement of the respective sensing signal.

In various embodiments, the processor 1400 may support wireless communication of a SensMF (e.g., one or more of a gNB, an LMF, an SF, or a combination thereof), in accordance with examples as disclosed herein. For example, the processor 1400 may be configured to support a means for determining a set of radio nodes for performing sensing signal transmission and sensing measurements. The set of radio nodes forms a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. Further, a starting vertex a respective directional edge corresponds to a transmitting radio node associated with a transmission of a respective sensing signal, and a terminating vertex of the respective directional edge corresponds to a receiving radio node associated with a reception and measurement of the respective sensing signal.

In some embodiments, the directional circular graph comprising N number of vertices (e.g., radio nodes described/numbered with indices of 1 . . . N) and N number of edges (e.g., sensing measurements described with indices of 1 . . . N) and where the directional edge n A): originates from the vertex node n and terminates at the node n+1, for n∈{1 . . . N−1}; and B) originates from the vertex node N and terminates at the node 1, for n=N. In certain embodiments, the numbering of the edges may correspond to the timing of the sensing signal, e.g., the first transmitted sensing signal is assigned to an edge of a lower index number, or may be assigned with any interpretation of the ordering of the nodes and/or edges, e.g., at random. In certain embodiments, the set of radio nodes comprises between two and four radio nodes that form the circular directional graph.

In some embodiments, the processor 1400 may be configured to support a means for transmitting, to the set of radio nodes, a sensing configuration for performing the sensing signal transmission and the sensing measurements. In some embodiments, the sensing configuration for performing the sensing signal transmission and the sensing measurements comprises an indication of one or more of: A) a time when a respective radio node of the set of radio nodes is to transmit or to receive a sensing signal, or both; or B) a set of time-frequency resources for transmitting the sensing signal, or for receiving the sensing signal, or both; or C) a combination thereof.

In certain embodiments, a set of transmission parameters for a transmission of the sensing signal (e.g., associated with edge n+1) is based at least in part on a sensing measurement (e.g., obtained/estimated measurement values/parameters) associated with a prior sensing signal (e.g., the sensing signal associated with edge n) at the respective radio node (e.g., node n∈{1 . . . N−1}).

In certain embodiments, the transmission of the sensing signal corresponds to a transmission beam adjustment based at least in part on an estimated direction of arrival of the prior sensing signal, where the estimated direction of arrival is measured on a propagation path associated with a sensing target.

In certain embodiments, the transmission of the sensing signal corresponds to a transmission time instance with an indicated time distance (e.g., an indicated Rx-to-Tx time difference as part of the configuration parameters) of a detected arrival time of the prior sensing signal via a propagation path associated with a sensing target. Note that the SensMF may indicate the time distance to the measurement radio node, and the measurement radio node utilizes the indicated time distance to generate its transmission (i.e., with the indicated time distance) to the reception of the prior signal from the identified path.

In certain embodiments, the transmission of the sensing signal corresponds to a transmission frequency or frequency/doppler shift, or both (e.g., applied to the sensing signal of the second measurement edge), with an indicated frequency distance (e.g., an indicated Rx-to-Tx frequency difference as part of configuration information) based at least in part on a detected (e.g., measured/estimated) frequency or doppler shift, or both, of the prior sensing signal via a propagation path associated with a sensing target. Note that the SensMF may indicate the frequency distance and the measurement radio node, and the measurement radio node utilizes the indicated frequency distance to generate its transmission (i.e., with the indicated frequency distance) to the reception of the prior signal from the identified path.

In certain embodiments, the sensing configuration further indicates a set of measurement parameters associated with a propagation path, where the set of measurement parameters comprises one or more of: a RSRPP, an AoA, a (ZoA), a ToA, a ToF, a doppler shift, or a combination thereof.

In certain embodiments, the sensing configuration comprises an identification of one or more reflective propagation paths associated with a sensing target object, where the identification of the one or more reflective propagation paths is based at least in part on a description of the one or more reflective propagation paths. For example, the description may be a permissible/potential range of path AoA, ZoA, arrival time, doppler shift, etc., according to the LCS of a measuring radio node (e.g., sensing Rx node) or a known/global coordinate system.

In certain embodiments, the sensing configuration comprises an identification of one or more propagation paths with LoS condition towards a sensing Rx radio node. For example, the description may be a permissible/potential range of path AoA, ZoA, arrival time, doppler shift, etc., according to the LCS of the measuring radio node (e.g., sensing Rx node) or a known/global coordinate system. In such embodiments, the one or more propagation paths the LoS condition are propagation paths associated to a sensing area of interest with LoS condition passing through a sensing area of interest when object may not be present and/or paths with LoS condition between two sensing Rx and sensing Tx node, for which the positioning/sensing information of the said sensing Rx and/or sensing Tx nodes are of interest.

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in a DL direction or a first SL direction, and a transmission of a second sensing signal on the propagation path in an UL direction or a second SL direction (i.e., the difference of the detected arrival time of a first sensing signal to the transmission time of the second sensing signal). In such embodiments, the reception, transmission, measurement of the UL, DL, SL, inter-RAN node directions imply reception timing, or transmission timing (or both), according to the UL/DL/SL frame timing at the radio node. In such embodiments, the respective radio node (i.e., UE radio node) is a vertex of ve as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in an UL direction or a first inter-RAN node direction, and a transmission of a second sensing signal on the propagation path in a DL direction or a second inter-RAN node direction (i.e., the difference of the detected arrival time of a first sensing signal to the transmission time of the second sensing signal). For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ve as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception frequency of a first sensing signal on a propagation path or a differential between the reception frequency of the first sensing signal on the propagation path in a DL direction or a first SL direction, and a transmission frequency of a second sensing signal on the propagation path in an UL direction or a second SL direction.

In some embodiments, the sensing configuration for a respective radio node comprises a reception frequency of a first sensing signal on a propagation path (e.g., a path associated to a sensing target, detected/identified by the respective radio node based on the configuration information (received from the SensMF) comprising description of the path) or a differential between the reception frequency of the first sensing signal on the propagation path in an UL direction or a first inter-RAN node direction, and a transmission frequency of a second sensing signal on the propagation path in a DL direction or a second inter-RAN node direction. For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ν_{c} as a terminating vertex of a first edge starting with a first UE or gNB/TRP node and starting vertex of a second edge ending with a second UE or gNB/TRP (e.g., the same as or different than the first UE or gNB/TRP node).

In some embodiments, the processor 1400 may be configured to support a means for receiving at least one measurement report corresponding to the sensing signal transmission and sensing measurements. In some embodiments, the processor 1400 may be configured to support a means for determining sensing information based at least in part on combined measurement values associated with the plurality of directional edges.

In certain embodiments, the combined measurement values include a sum of a respective propagation delay of a set of propagation paths along the plurality of directional edges (e.g., sum of the propagation delay of paths associated with sensing target reflection, or sum of the propagation delay of the paths with first-arrival or LoS condition between the vertices of each edge). In such embodiments, the sum may be determined by summation of the measured and reported ToF, or by the total time of the first sensing signal transmission at the first edge to the last signal reception at the last edge from which the Rx (from the propagation path associated to the sensing target)-to-Tx time difference of all nodes (other than the first node, corresponding to the transmitter of the first sensing signal) is subtracted.

In certain embodiments, the combined measurement values include a sum of a respective doppler frequency shift of a set of propagation paths along the plurality of directional edges (e.g., sum of the doppler frequency shifts of paths associated with sensing target reflection, or sum of the doppler frequency shifts of the paths with first-arrival or LoS condition between the vertices of each edge). In such embodiments, the said sum may be determined by summation of the measured and reported doppler shift, or by the total frequency difference of the first sensing signal transmission at the first edge to the last signal reception at the last edge from which the Rx (from the propagation path associated to the sensing target)-to-Tx frequency shift/difference of all intermediate nodes is subtracted.

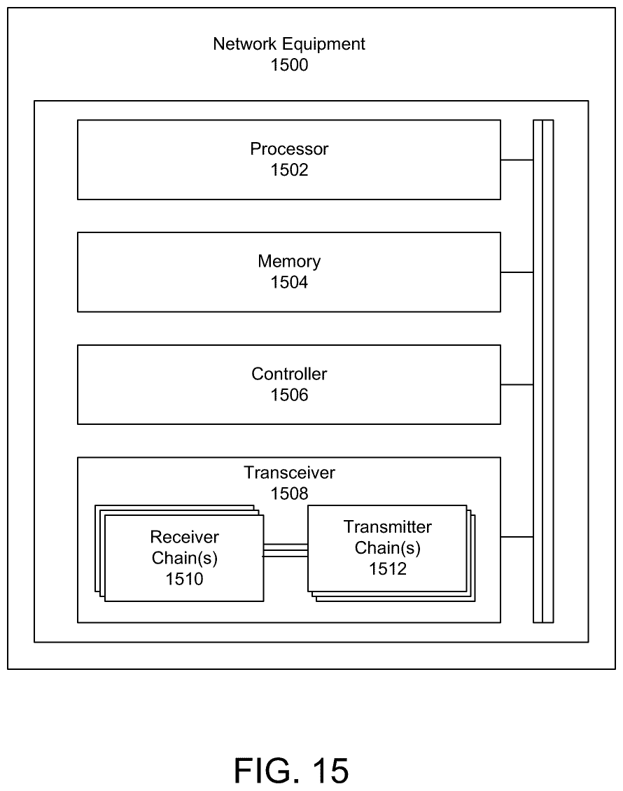

FIG. 15 illustrates an example of a NE 1500 in accordance with aspects of the present disclosure. The NE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the NE 1500 to perform various functions of the present disclosure.

The memory 1504 may include volatile or non-volatile memory. The memory 1504 may store computer-readable, computer-executable code including instructions when executed by the processor 1502 cause the NE 1500 to perform various functions described herein. The code may be stored in a non-transitory computer-readable medium such the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the NE 1500 to perform one or more of the SensMF functions described herein (e.g., executing, by the processor 1502, instructions stored in the memory 1504). For example, the processor 1502 may support wireless communication at the NE 1500 in accordance with examples as disclosed herein. The NE 1500 may be configured to support a means for determining a set of radio nodes for performing sensing signal transmission and sensing measurements. The set of radio nodes forms a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. Further, a starting vertex a respective directional edge corresponds to a transmitting radio node associated with a transmission of a respective sensing signal, and a terminating vertex of the respective directional edge corresponds to a receiving radio node associated with a reception and measurement of the respective sensing signal.

In some embodiments, the directional circular graph comprising N number of vertices (e.g., radio nodes described/numbered with indices of 1 . . . N) and N number of edges (e.g., sensing measurements described with indices of 1 . . . N) and where the directional edge n A): originates from the vertex node n and terminates at the node n+1, for n∈{1 . . . N−1}; and B) originates from the vertex node N and terminates at the node 1, for n=N. In certain embodiments, the numbering of the edges may correspond to the timing of the sensing signal, e.g., the first transmitted sensing signal is assigned to an edge of a lower index number, or may be assigned with any interpretation of the ordering of the nodes and/or edges, e.g., at random. In certain embodiments, the set of radio nodes comprises between two and four radio nodes that form the circular directional graph.

In some embodiments, the NE 1500 may be configured to support a means for transmitting, to the set of radio nodes, a sensing configuration for performing the sensing signal transmission and the sensing measurements. In some embodiments, the sensing configuration for performing the sensing signal transmission and the sensing measurements comprises an indication of one or more of: A) a time when a respective radio node of the set of radio nodes is to transmit or to receive a sensing signal, or both; or B) a set of time-frequency resources for transmitting the sensing signal, or for receiving the sensing signal, or both; or C) a combination thereof.

In certain embodiments, a set of transmission parameters for a transmission of the sensing signal (e.g., associated with edge n+1) is based at least in part on a sensing measurement (e.g., obtained/estimated measurement values/parameters) associated with a prior sensing signal (e.g., the sensing signal associated with edge n) at the respective radio node (e.g., node n∈{1 . . . N−1}).

In certain embodiments, the transmission of the sensing signal corresponds to a transmission beam adjustment based at least in part on an estimated direction of arrival of the prior sensing signal, such that the estimated direction of arrival is measured on a propagation path associated with a sensing target.

In certain embodiments, the transmission of the sensing signal corresponds to a transmission time instance with an indicated time distance (e.g., an indicated Rx-to-Tx time difference as part of the configuration parameters) of a detected arrival time of the prior sensing signal via a propagation path associated with a sensing target. Note that the SensMF may indicate the time distance to the measurement radio node, and the measurement radio node utilizes the indicated time distance to generate its transmission (i.e., with the indicated time distance) to the reception of the prior signal from the identified path.

In certain embodiments, the transmission of the sensing signal corresponds to a transmission frequency or frequency/doppler shift, or both (e.g., applied to the sensing signal of the second measurement edge), with an indicated frequency distance (e.g., an indicated Rx-to-Tx frequency difference as part of configuration information) based at least in part on a detected (e.g., measured/estimated) frequency or doppler shift, or both, of the prior sensing signal via a propagation path associated with a sensing target. Note that the SensMF may indicate the frequency distance and the measurement radio node, and the measurement radio node utilizes the indicated frequency distance to generate its transmission (i.e., with the indicated frequency distance) to the reception of the prior signal from the identified path.

In certain embodiments, the sensing configuration further indicates a set of measurement parameters associated with a propagation path, where the set of measurement parameters comprises one or more of: a RSRPP, an AoA, a ZoA, a ToA, a ToF, a doppler shift, or a combination thereof.

In certain embodiments, the sensing configuration comprises an identification of one or more reflective propagation paths associated with a sensing target object, such that the identification of the one or more reflective propagation paths is based at least in part on a description of the one or more reflective propagation paths. For example, the description may be a permissible/potential range of path AoA, ZoA, arrival time, doppler shift, etc., according to the LCS of a measuring radio node (e.g., sensing Rx node) or a known/global coordinate system.

In certain embodiments, the sensing configuration comprises an identification of one or more propagation paths with LoS condition towards a sensing Rx radio node. For example, the description may be a permissible/potential range of path AoA, ZoA, arrival time, doppler shift, etc., according to the LCS of the measuring radio node (e.g., sensing Rx node) or a known/global coordinate system. In such embodiments, the one or more propagation paths the LoS condition are propagation paths associated to a sensing area of interest with LoS condition passing through a sensing area of interest when object may not be present and/or paths with LoS condition between two sensing Rx and sensing Tx node, for which the positioning/sensing information of the said sensing Rx and/or sensing Tx nodes are of interest.

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in a DL direction or a first SL direction, and a transmission of a second sensing signal on the propagation path in an UL direction or a second SL direction (i.e., the difference of the detected arrival time of a first sensing signal to the transmission time of the second sensing signal). In such embodiments, the reception, transmission, measurement of the UL, DL, SL, inter-RAN node directions imply reception timing, or transmission timing (or both), according to the UL/DL/SL frame timing at the radio node. In such embodiments, the respective radio node (i.e., UE radio node) is a vertex of ν_{c} as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception time of a first sensing signal on a propagation path (e.g., a path associated to a sensing target, detected/identified by the respective radio node based on configuration information (i.e., received from the SensMF) comprising a description of the path) or a time differential between the reception of the first sensing signal on the propagation path in an UL direction or a first inter-RAN node direction, and a transmission of a second sensing signal on the propagation path in a DL direction or a second inter-RAN node direction (i.e., the difference of the detected arrival time of a first sensing signal to the transmission time of the second sensing signal). For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ve as a terminating vertex of a first edge starting with a first UE or gNB/TRP node and starting vertex of a second edge ending with a second UE or gNB/TRP (e.g., the same as or different than the first UE or gNB/TRP node).

In some embodiments, the sensing configuration for a respective radio node comprises a reception frequency of a first sensing signal on a propagation path or a differential between the reception frequency of the first sensing signal on the propagation path in a DL direction or a first SL direction, and a transmission frequency of a second sensing signal on the propagation path in an UL direction or a second SL direction.

In some embodiments, the sensing configuration for a respective radio node comprises a reception frequency of a first sensing signal on a propagation path (e.g., a path associated to a sensing target, detected/identified by the respective radio node based on the configuration information (received from the SensMF) comprising description of the path) or a differential between the reception frequency of the first sensing signal on the propagation path in an UL direction or a first inter-RAN node direction, and a transmission frequency of a second sensing signal on the propagation path in a DL direction or a second inter-RAN node direction. For example, an inter-RAN node direction may correspond to an edge starting with a first RAN node and terminating at a second (i.e., similar or different) RAN node, e.g., direction corresponding to transmission of one RAN node (e.g., a TRP, a gNB, an NCR, an IAB node, etc.) and reception of another RAN node. In such embodiments, the respective radio node (i.e., RAN radio node) is a vertex of ν_{c} as a terminating vertex of a first edge starting with a first UE or gNB/TRP node and starting vertex of a second edge ending with a second UE or gNB/TRP (e.g., the same as or different than the first UE or gNB/TRP node).

In some embodiments, the NE 1500 may be configured to support a means for receiving at least one measurement report corresponding to the sensing signal transmission and sensing measurements. In some embodiments, the NE 1500 may be configured to support a means for determining sensing information based at least in part on combined measurement values associated with the plurality of directional edges.

In certain embodiments, the combined measurement values include a sum of a respective propagation delay of a set of propagation paths along the plurality of directional edges (e.g., sum of the propagation delay of paths associated with sensing target reflection, or sum of the propagation delay of the paths with first-arrival or LoS condition between the vertices of each edge). In such embodiments, the sum may be determined by summation of the measured and reported ToF, or by the total time of the first sensing signal transmission at the first edge to the last signal reception at the last edge from which the Rx (from the propagation path associated to the sensing target)-to-Tx time difference of all nodes (other than the first node, corresponding to the transmitter of the first sensing signal) is subtracted.

In certain embodiments, the combined measurement values include a sum of a respective doppler frequency shift of a set of propagation paths along the plurality of directional edges (e.g., sum of the doppler frequency shifts of paths associated with sensing target reflection, or sum of the doppler frequency shifts of the paths with first-arrival or LoS condition between the vertices of each edge). In such embodiments, the said sum may be determined by summation of the measured and reported doppler shift, or by the total frequency difference of the first sensing signal transmission at the first edge to the last signal reception at the last edge from which the Rx (from the propagation path associated to the sensing target)-to-Tx frequency shift/difference of all intermediate nodes is subtracted.

In some implementations, the processor 1502 and the memory 1504 coupled with the processor 1502 may be configured to cause the NE 1500 to perform one or more of the measurement node and/or radio sensing node functions described herein (e.g., executing, by the processor 1502, instructions stored in the memory 1504). For example, the processor 1502 may support wireless communication at the NE 1500 in accordance with examples as disclosed herein. The NE 1500 may be configured to support a means for receiving a sensing configuration for performing a sensing signal transmission and at least one sensing measurement and means for performing at least one sensing measurement based on a first sensing signal.

In various embodiments, the NE 1500 may be configured to support a means for transmitting a second sensing signal in accordance with the sensing configuration, such that the sensing configuration indicates a time difference between a reception of the first sensing signal and a time of transmission of the second sensing signal, or a time difference between a reception of the first sensing signal and a time reference, or a frequency difference between the reception of the first sensing signal and a transmission frequency of the second sensing signal, or a frequency difference between the reception of the first sensing signal and a reference frequency, or a combination thereof.

In certain embodiments, the NE 1500 may be configured to receive an indication of the time reference associated with the second sensing signal, or the reference frequency associated with the second sensing signal, or both. In certain embodiments, the time reference associated indicates the start of the closest symbol, or slot, or subframe, to the reception of the first sensing signal or the transmission of the second sensing signal. In certain embodiments, the reference frequency associated with the second sensing signal indicates the starting frequency of a physical resource block within the transmission frame associated with the second sensing signal. In other embodiments, the reference frequency indicates an expected reception frequency of the first sensing signal assuming a static environment and static radio nodes.

In some embodiments, the sensing configuration further indicates one or more of: A) a time of the reception of the first sensing signal; B) a set of reception time-frequency resources for receiving the first sensing signal; C) a set of transmission time-frequency resources for transmitting the second sensing signal; or D) a combination thereof.

In some embodiments, the sensing configuration further indicates a set of measurement parameters associated with a propagation path, where the set of measurement parameters comprises one or more of: a RSRPP, an AoA, a ZoA, a ToA, a ToF, a doppler shift, a path-specific Rx-to-Tx time difference (i.e., Rx(path)-to-TX time difference), a path-specific Tx-to-Rx time difference (i.e., Tx-to-Rx(path) time difference), a path-specific Rx-to-Tx frequency difference (i.e., Rx(path)-to-TX frequency difference), a path specific Tx-to-Rx frequency difference (i.e., Tx-to-Rx(path) frequency difference), or a combination thereof.

In some embodiments, the sensing configuration comprises an identification of one or more reflective propagation paths associated with a sensing target object, such that the identification of the one or more reflective propagation paths is based at least in part on a description of the one or more reflective propagation paths. In some embodiments, the sensing configuration comprises an identification of one or more propagation paths with LoS condition towards a sensing Rx radio node.

In various embodiments, the NE 1500 may be configured to support a means for transmitting a measurement report based at least in part on the at least one sensing measurement. In some embodiments, the NE 1500 is further configured to receiving a reporting configuration for the measurement report, where the measurement report indicates a measured time delay between an arrival time (i.e., time of reception) of the first sensing signal and the transmission of the second sensing signal or a frequency shift between a detected frequency of the first sensing signal and the transmission frequency of the second sensing signal, or both.

In certain embodiments, the reporting configuration indicates a timing or condition for a transmission of the measurement report. More specifically, the reporting configuration may include at least one type of measurement quantities to be reported, and one or more conditions over which the measured quantities are obtained, e.g., when measurement of the frequency of the first sensing signal is performed based on a portion of the first sensing signal the measured time-window of the received first sensing signal is also reported (e.g., K number of time-periods of a first sensing signal with periodic resource assignment), the estimated accuracy of the obtained measurement quantities, or a combination thereof. In some examples, upon reception of the reporting configuration comprising a time pattern for possible reporting occasions and at least one reporting condition (e.g., the measured RSRPP of the detected path of the first sensing signal is above an indicated threshold to the radio node) the radio node determines the closest reporting occasion to the time instance that the satisfaction of the said one or more conditions are determined and utilized the said reporting occasion for transmission of the report.

In some embodiments, a set of transmission parameters for the transmission of the second sensing signal is based at least in part on the at least one sensing measurement. For example, the set of transmission parameters may indicate a transmission beam, a time difference to be applied/enforced, a frequency difference to be applied/enforced, etc.

In certain embodiments, to transmit the second sensing signal, the processor 1400 is further configured to adjust a transmission beam based at least in part on an estimated direction of arrival of the first sensing signal, such that the estimated direction of arrival is measured on a propagation path associated with a sensing target.

In certain embodiments, the time of transmission of the second sensing signal is based on the indicated time difference and an arrival time of the first sensing signal via a propagation path associated with a sensing target.

In certain embodiments, the transmission frequency of the second sensing signal is based on the indicated frequency difference (e.g., the indicated subcarrier resource of the second sensing signal and the difference thereof with the assigned subcarrier resource of the first sensing signal, e.g., zero distance in case of the same subcarrier resource assignment are used for transmission of the second sensing signal and reception of the first sensing signal) and a detected frequency or detected doppler shift, or both, of the first sensing signal via a propagation path associated with a sensing target (e.g., detected frequency of the first sensing signal arriving from the path associated with sensing signal is shifted according to the indicated said distance to generate the transmission of the second sensing signal, or the detected doppler shift of the first sensing signal is added to the transmission frequency scheduled/assigned for the second sensing signal, e.g., by applying a time/symbol-dependent phase rotation over the duration of the second sensing signal at the subcarrier/time resources indicated for the transmission of the second sensing signal).

In some embodiments, the processor 1400 is further configured to identify a respective propagation path based at least in part on: A) an indicated propagation time/delay characteristic of the respective propagation path; B) an indicated propagation path directional information of the respective propagation path; C) an indicated movement/mobility pattern associated with the respective propagation path; D) an indicated energy/power associated with the respective propagation path; E) an indicated pattern describing a group of paths where the path is a member of the group of paths; F) an indicated relative description of an identified path or a known path; or G) a combination thereof.

In some embodiments, the NE 1500 receives the first sensing signal on a propagation path in an UL direction or a first inter-RAN node direction, and transmits the second sensing signal on the propagation path in a DL direction or a second inter-RAN node direction.

In some embodiments, the sensing configuration indicates a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. In such embodiments, a starting vertex a respective directional edge corresponds to a transmitting radio node associated with a transmission of a respective sensing signal, and where a terminating vertex of the respective directional edge corresponds to a receiving radio node associated with a reception and measurement of the respective sensing signal.

The controller 1506 may manage input and output signals for the NE 1500. The controller 1506 may also manage peripherals not integrated into the NE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the NE 1500 may include at least one transceiver 1508. In some other implementations, the NE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas for receiving the signal over the air or wireless medium. The receiver chain 1510 may include at least one amplifier (e.g., a low-noise amplifier (LNA)) configured to amplify the received signal. The receiver chain 1510 may include at least one demodulator configured to demodulate the received signal and obtain the transmitted data by reversing the modulation technique applied during transmission of the signal. The receiver chain 1510 may include at least one decoder for decoding/processing the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

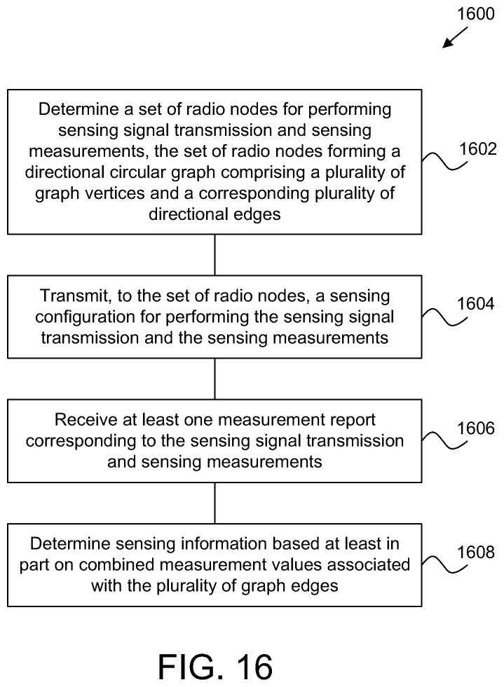

FIG. 16 depicts one embodiment of a method 1600 in accordance with aspects of the present disclosure. The operations of the method 1600 may be implemented by a SensMF as described herein. As described above, the SensMF may be a UE, a gNB/RAN node, an SF, or a combination thereof. In some implementations, the SensMF may execute a set of instructions to control the function elements of the SensMF to perform the described functions.

At step 1602, the method 1600 may include determining a set of radio nodes for performing sensing signal transmission and sensing measurements. The set of radio nodes forms a directional circular graph comprising a plurality of graph vertices and a corresponding plurality of directional edges, where each of the plurality of graph vertices corresponds to a radio node for performing sensing signal transmission and sensing measurements, and where each of the plurality of directional edges corresponds to a sensing measurement. Further, a starting vertex a respective directional edge corresponds to a transmitting radio node associated with a transmission of a respective sensing signal, and a terminating vertex of the respective directional edge corresponds to a receiving radio node associated with a reception and measurement of the respective sensing signal. The operations of step 1602 may be performed in accordance with examples as described herein. In some implementations, aspects of the operations of step 1602 may be performed by a UE, as described with reference to FIG. 13, or by a NE, as described with reference to FIG. 15.

At step 1604, the method 1600 may include transmitting, to the set of radio nodes, a sensing configuration for performing the sensing signal transmission and the sensing measurements. The operations of step 1604 may be performed in accordance with examples as described herein. In some implementations, aspects of the operations of step 1604 may be performed by a UE, as described with reference to FIG. 13, or by a NE, as described with reference to FIG. 15.

At step 1606, the method 1600 may include receiving at least one measurement report corresponding to the sensing signal transmission and sensing measurements. The operations of step 1606 may be performed in accordance with examples as described herein. In some implementations, aspects of the operations of step 1606 may be performed by a UE, as described with reference to FIG. 13, or by a NE, as described with reference to FIG. 15.

At step 1608, the method 1600 may include determining sensing information based at least in part on combined measurement values associated with the plurality of directional edges. The operations of step 1608 may be performed in accordance with examples as described herein. In some implementations, aspects of the operations of step 1608 may be performed by a UE, as described with reference to FIG. 13, or by a NE, as described with reference to FIG. 15.

It should be noted that the method 1600 described herein describes one possible implementation, and that the operations and the steps may be rearranged or otherwise modified and that other implementations are possible.

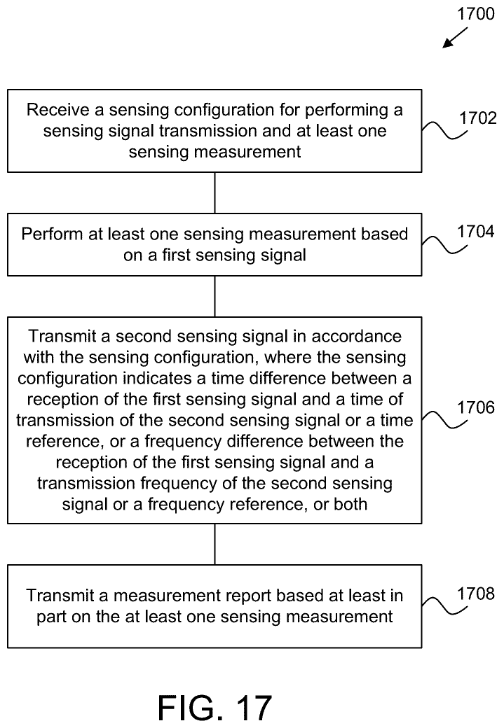

FIG. 17 depicts one embodiment of a method 1700 in accordance with aspects of the present disclosure. In various embodiments, the operations of the method 1700 may be implemented by a measurement node, as described herein. As described, the measurement node is a radio node participating in a radio sensing task and may be a UE or a gNB/TRP. In some implementations, the radio node may execute a set of instructions to control the function elements of the radio node to perform the described functions.

At step 1702, the method 1700 may include receiving a sensing configuration for performing a sensing signal transmission and at least one sensing measurement. The operations of step 1702 may be performed in accordance with examples as described herein. In some implementations, aspects of the operation of step 1702 may be performed by a UE, as described with reference to FIG. 13, or by a NE, as described with reference to FIG. 15.

At step 1704, the method 1700 may include performing at least one sensing measurement based on a first sensing signal. The operations of step 1704 may be performed in accordance with examples as described herein. In some implementations, aspects of the operation of step 1704 may be performed by a UE, as described with reference to FIG. 13, or by a NE, as described with reference to FIG. 15.

At step 1706, the method 1700 may include transmitting a second sensing signal in accordance with the sensing configuration, wherein the sensing configuration indicates a time difference between a reception of the first sensing signal and a time of transmission of the second sensing signal or an indicate time reference, or a frequency difference between the reception of the first sensing signal and a transmission frequency of the second sensing signal or an indicated frequency reference, or both. The operations of step 1706 may be performed in accordance with examples as described herein. In some implementations, aspects of the operation of step 1706 may be performed by a UE, as described with reference to FIG. 13, or by a NE, as described with reference to FIG. 15.

At step 1708, the method 1700 may include transmitting a measurement report based at least in part on the at least one sensing measurement. The operations of step 1708 may be performed in accordance with examples as described herein. In some implementations, aspects of the operation of step 1706 may be performed by a UE, as described with reference to FIG. 13, or by a NE, as described with reference to FIG. 15.

It should be noted that the method 1700 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a sensing configuration for performing a sensing signal transmission and at least one sensing measurement;
perform at least one sensing measurement based on a first sensing signal;
transmit a second sensing signal in accordance with the sensing configuration, wherein the sensing configuration indicates a time difference between a reception of the first sensing signal and a time of transmission of the second sensing signal or a time reference, or a frequency difference between the reception of the first sensing signal and a transmission frequency of the second sensing signal or a frequency reference, or both; and
transmit a measurement report based at least in part on the at least one sensing measurement.

2. The UE of claim 1, wherein the at least one processor is further configured to cause the UE to receive a reporting configuration that indicates a timing or condition for a transmission of the measurement report, wherein the measurement report indicates a measured time delay between an arrival time of the first sensing signal and the transmission of the second sensing signal or a frequency shift between a detected frequency of the first sensing signal and the transmission frequency of the second sensing signal, or both.

3. The UE of claim 1, wherein a set of transmission parameters for the transmission of the second sensing signal is based at least in part on the at least one sensing measurement.

4. The UE of claim 3, wherein to transmit the second sensing signal, the at least one processor is configured to cause the UE to adjust a transmission beam based at least in part on an estimated direction of arrival of the first sensing signal, and wherein the estimated direction of arrival is measured on a propagation path associated with a sensing target.

5. The UE of claim 3, wherein the time of transmission of the second sensing signal is based on the time difference and an arrival time of the first sensing signal via a propagation path associated with a sensing target.

6. The UE of claim 3, wherein the transmission frequency of the second sensing signal is based on the frequency difference and a detected frequency or detected doppler shift, or both, of the first sensing signal via a propagation path associated with a sensing target.

7. The UE of claim 1, wherein the sensing configuration further indicates a set of measurement parameters associated with a propagation path, wherein the set of measurement parameters comprises one or more of: reference signal received path power (RSRPP), angle of arrival (AoA), zenith of arrival (ZoA), time of arrival (ToA), time of flight (ToF), doppler shift, a path-specific receive-to-transmit (Rx-to-Tx) time difference, a path-specific transmit-to-receive (Tx-to-Rx) time difference, a path-specific Rx-to-Tx frequency difference, a path specific Tx-to-Rx frequency difference, or a combination thereof.

8. The UE of claim 1, wherein the sensing configuration comprises an identification of one or more reflective propagation paths associated with a sensing target object, and wherein the identification of the one or more reflective propagation paths is based at least in part on a description of the one or more reflective propagation paths.

9. The UE of claim 1, wherein the sensing configuration comprises an identification of one or more propagation paths with line-of-sight (LoS) condition towards a sensing receive (Rx) radio node.

10. The UE of claim 1, wherein the at least one processor is configured to cause the UE to identify a respective propagation path based at least in part on:
an indicated propagation time/delay characteristic of the respective propagation path;
an indicated propagation path directional information of the respective propagation path;
an indicated movement/mobility pattern associated with the respective propagation path;
an indicated energy/power associated with the respective propagation path;
an indicated pattern describing a group of paths wherein the path is a member of the group of paths;
an indicated relative description of an identified path or a known path;
or a combination thereof.

11. The UE of claim 1, wherein the at least one processor is configured to cause the UE to receive the first sensing signal on a propagation path in a downlink direction or a first SL direction, and to transmit the second sensing signal on the propagation path in an uplink direction or a second SL direction.

12. The UE of claim 1, wherein the sensing configuration indicates a directional circular graph comprising a plurality of graph vertices and a corresponding plurality of directional edges, wherein each of the plurality of graph vertices corresponds to a radio node for performing sensing signal transmission and sensing measurements, wherein each of the plurality of directional edges corresponds to a sensing measurement, wherein a starting vertex a respective directional edge corresponds to a transmitting radio node associated with a transmission of a respective sensing signal, and wherein a terminating vertex of the respective directional edge corresponds to a receiving radio node associated with a reception and measurement of the respective sensing signal.

13. A processor for wireless communication, comprising:
at least one controller coupled with at least one memory and configured to cause the processor to:
receive a sensing configuration for performing a sensing signal transmission and at least one sensing measurement;
perform at least one sensing measurement based on a first sensing signal;
transmit a second sensing signal in accordance with the sensing configuration, wherein the sensing configuration indicates a time difference between a reception of the first sensing signal and a time of transmission of the second sensing signal or a time reference, or a frequency difference between the reception of the first sensing signal and a transmission frequency of the second sensing signal or a frequency reference, or both; and
transmit a measurement report based at least in part on the at least one sensing measurement.

14. A base station for wireless communication, comprising:
at least one memory; and
at least one processor coupled with the at least one memory and configured to cause the base station to:
determine a set of radio nodes for performing sensing signal transmission and sensing measurements, the set of radio nodes forming a directional circular graph comprising a plurality of graph vertices and a corresponding plurality of directional edges, wherein each of the plurality of graph vertices corresponds to a radio node for performing sensing signal transmission and sensing measurements, wherein each of the plurality of directional edges corresponds to a sensing measurement, wherein a starting vertex a respective directional edge corresponds to a transmitting radio node associated with a transmission of a respective sensing signal, and wherein a terminating vertex of the respective directional edge corresponds to a receiving radio node associated with a reception and measurement of the respective sensing signal; and
transmit, to the set of radio nodes, a sensing configuration for performing the sensing signal transmission and the sensing measurements;
receive at least one measurement report corresponding to the sensing signal transmission and sensing measurements; and
determine sensing information based at least in part on combined measurement values associated with the plurality of directional edges.

15. The base station of claim 14, wherein the directional circular graph comprising N number of vertices and N number of edges, and wherein a directional edge n
originates from a vertex node n and terminates at a node n+1, for n∈{1 . . . N−1}
originates from a vertex node N and terminates at a node 1, for n=N.

16. The base station of claim 14, wherein the sensing configuration comprises an indication of one or more of:
a time when a respective radio node of the set of radio nodes is to transmit or to receive a sensing signal, or both; or
a set of time-frequency resources for transmitting the sensing signal, or for receiving the sensing signal, or both.

17. The base station of claim 14, wherein the combined measurement values comprise a sum of a respective propagation delay of a set of propagation paths along the plurality of directional edges.

18. The base station of claim 14, wherein the combined measurement values comprise a sum of a respective doppler frequency shift of a set of propagation paths along the plurality of directional edges.

19. The base station of claim 14, wherein the sensing configuration comprises a reception time of a first sensing signal on a propagation path or a time differential between the reception of the first sensing signal on the propagation path in a downlink direction or a first SL direction, and a transmission of a second sensing signal on the propagation path in an uplink direction or a second SL direction.

20. The base station of claim 14, wherein the sensing configuration comprises a reception frequency of a first sensing signal on a propagation path or a differential between the reception frequency of the first sensing signal on the propagation path in a downlink direction or a first SL direction, and a transmission frequency of a second sensing signal on the propagation path in an uplink direction or a second SL direction.
